(19) United States
(12) Patent Application Publication
(10) Pub. No.: US 2007/0150240 A1
(43) Pub. Date: Jun. 28, 2007

(54) AUTOMATED SELECTION OF OPTICAL SYSTEMS

(76) Inventor: WILLIAM DOUGLAS BRIDSON, Ontario, NY (US)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/554,361

(22) Filed: Oct. 30, 2006

Related U.S. Application Data
(63) Continuation-in-part of application No. 10/961,517, filed on Oct. 7, 2004, now Pat. No. 7,149,662.

(51) Int. Cl. G06F 17/50

(52) U.S. Cl. 703/1

(57) ABSTRACT

An automated system for designing or engineering an optical system that compares a set of user requirements (translated into corresponding optical characteristics) with the optical characteristics of a plurality of standard optical components, and automatically and interactively working with the user processes through a program to enable the user to obtain an engineered solution that meets his requirements. The method is performed using a programmed computer which may be remotely interfaced with the user via the Internet. The user inputs his requirements via a screen or page, and the computer located at a central station responds, and in a single session, works with the user automatically and interactively to obtain a solution to the user's needs. The user may optionally specify that the system be designed using a particular product line or family of standard products.

### RELATED APPLICATION

This application is a continuation-in-part of application Ser. No. 10/961,517 filed Oct. 7, 2004, the contents of which are here incorporated by reference in their entirety. Applicant claims the benefits of 35 USC 120.

### BACKGROUND OF THE INVENTION

1. Field Of The Invention

The present invention broadly relates to optical systems, and deals more particularly with the automated selection of optical systems using standardized optical components.

2. Prior Art

A variety of optical systems are commonly used to perform inspection or monitoring processes in industrial applications. In some cases, human operators use the optical systems to view objects, surface features or other phenomenon of interest. In other cases, optical systems are used as part of “machine vision” systems to automatically perform inspection or recognition processes. Machine vision systems typically include a camera or similar recording device which includes an optical lens for imaging an object onto a sensor comprising either a linear or two dimensional array of pixels that electronically record an image of the object and convert it to a digitized pixel stream that is processed by a machine vision processor. The processor typically forms part of a programmed computer that operates on the digitized pixel stream to determine whether certain characteristics are present in the image, and displays the recorded image or feature of interest on a monitor.

Optical systems of the type mentioned above are often designed using a number of relatively standard, off-the-shelf components, such as specialized lens systems, illumination sources, focusing mechanisms and camera mounts. A variety of lenses may be employed, depending upon the application, such as micro lenses, macro lenses, zoom lenses, and other lens combinations which are well known in the art.

In designing optical lens systems for machine vision and other applications, a variety of well known formulas and guidelines have been developed to aid in selecting an optical system for specific industrial applications. For example, it is known that as the numerical aperture increases, the depth of field decreases and resolution increases. As magnification increases, the field of view decreases and more light may therefore be needed. Further, for example, it is well known that magnification is developed in two ways—either by using different lenses and different magnifications at the camera, or by using camera and monitor combinations that develop magnification between themselves. Similar rules and guidelines have been developed relating to depth of field, depth of focus, distortion, resolution, object-to-image distance, working distance, etc.

In the past, in order to specify an optical system for a specific application, such as a machine vision inspection application, an optical system engineer would manually review the requirements for the application and then select a combination of standardized optical components that function in combination to meet the application requirements. While this prior “manual” approach to specifying optical systems generally provided satisfactory results, the process could be time consuming, and required an involvement of an individual with considerable optical background (which defeats the “one stop shopping” concept of using the Internet). Moreover, there could be a substantial delay in providing a customer or user with the final results of the design process.

Accordingly, there is a need in the art for an automated method of selecting an optical system which overcomes each of the disadvantages of the prior art discussed above.

### SUMMARY OF THE INVENTION

According to one aspect of the invention, automated selection of an optical system, comprises the steps of: generating a set of user requirements that include a set of data defining the user's optical imaging specification; generating a second data set defining optical characteristics of each of a plurality of standardized optical devices; generating a set of programmed instructions for comparing the first data set with the second data set: and, using a programmed computer to automatically select a combination of the optical devices that function to essentially satisfy the user's optical imaging specifications. The first data set is generated by recording data defining optical characteristics of a sensor upon which the object will be imaged, recording data defining characteristics of the object, and recording data defining the working distance between the sensor and the object. The sensor characteristics preferably include at least the length of one side of the sensor. The first data set is generated by manually inputting data using a remote user data terminal. In a preferred embodiment the user data is transmitted from the remote user terminal over the internet to a local server site which includes a program computer for analyzing the optical characteristics of a set of standard optical devices and selecting a combination of the optical devices that functionally satisfy the user's requirements.

According to another aspect of the invention, a method for selecting an optical imagining system is provided which employs a programmed computer. The method includes the steps of recording a first set of user data defining a user's specifications for an optical imaging system wherein the first data set includes data relating to the size of the sensor onto which an object is to be imaged, the size of pixels used in the sensor, and the largest dimension of the object to be imaged. The method further includes the steps of determining the optical magnification required by the system to image the object, generating a second set of design data defining optical characteristics of each of a plurality of optical devices, and using a computer, the first and second sets of data and the determined magnification to automatically select a combination of optical devices that function to satisfy the user's specifications within a predetermined tolerance range.

According to still another aspect of the invention, an automated system for selecting optical apparatus, comprises a data input table having fixed data input fields into which a user may input data defining the user's specifications for the optical system, an information storage system for storing the optical characteristics of a plurality of optical devices that may be selected to form the optical system, and a processor for analyzing the user data entered into the input table and for selecting a combination of the optical devices that function to essentially meet the user's specifications.

According, it is a primary object of the invention to provide a method for selecting an optical system which speeds the design process by automating various steps of the process, and eliminates the need for the optical “expert”.

Another object of the invention is to provide a method as mentioned above which employs a programmed computer to select optical components to meet a user's optical system requirements.

A further object of the invention is to provide a method for selecting an optical system which eliminates the possibility of guess work or error by using automated selection of optical components.

A still further object of the invention is to provide a method as described above which allows a remote user or customer to select an optical system using an automated design process, and rapidly receive the design results.

Another object of the invention is to provide a method of the type mentioned which essentially eliminates the need for a human designer to assess the user's requirements and manually develop an optical system meeting those requirements.

Another embodiment of the invention relates to an advanced online tool in the form of a computer application (including appropriate algorithms) resident in a computer connected to the Internet that automatically responds to a user inquiry, and thereafter, steps the user through a set of questions to identify the best optical solution for the user's specific electronic imaging or machine vision application. This designing and engineering activity occurs interactively and automatically in a single session via the Internet. If possible, the tool presents initially a set of applicable lens options that fit the user's requirements, as expressed in the user's inputs, together with specific performance specifications for each. The application goes on to compare each lens option in performance with the user inputs. The user then selects one option, which may involve a revision of the user's original inputs, and the tool further customizes the selected option. As a last step, the tool will provide a list of complete parts, drawings and a final price, together with an option to purchase immediately online or alternatively, to locate a dealer and integration partner convenient to the user.

These, and further objects and advantages of the invention will be made clear or will become apparent during the course of the following description of a preferred embodiment of the invention.

### BRIEF DESCRIPTION OF THE DRAWINGS

In the drawings, which form an integral part of the specification, and are to be read in conjunction therewith, and which like reference numerals are employed to designate identical components in the various views:

FIG. 1 is a functional block diagram of an automated system for selecting optical apparatus which forms the preferred embodiment of the invention;

FIG. 2 is a customer input form allowing a customer to input final performance specifications for the optical system:

FIGS. 3A and 3B, taken together, form a table showing the characteristics for each of a plurality of optical components used to select the optical system; and

FIG. 4 is a flow chart showing the steps of the automated method used to select the optical system.

FIGS. 5a and 5b show an opening screen on which a user provides inputs, for a second and preferred embodiment of the present invention.

FIG. 6 shows a response screen from the central station where the user is cautioned that user's request for coax has resulted in user's field of view being too large.

FIGS. 7a and 7b show another opening screen where user has modified inputs to conform to the request for coax per the response screen of FIG. 6.

FIGS. 8a and 8b show the response screen from the central station indicating “no matches found”, but suggesting modifications to the inputs.

FIGS. 9a and 9b show the response screen from the central station after user has specifically requested a 12× Zoom lens, indicating “no matches found”, although mag looks OK, coax restrictions should be checked.

FIG. 10 shows the screen opened from the central station after user has clicked on “Coaxial Operating Restrictions”.

FIGS. 11a and 11b show the screen opened from the central station after user has modified his inputs to reduce the field, to provide a 12× Zoom solution.

FIG. 12 shows a generic picture of the final system, so the user knows what further items must be chosen.

FIG. 13 shows the screen indicating the user's desire for a motorized zoom drive.

FIG. 14 shows the screen whereby user checks the help section to determine how the motor is to be driven.

FIGS. 15a and 15b show the help screen for motor drivers.

FIG. 16 shows the screen whereby choice is made.

FIG. 17 shows the screen for input of wall voltage.

FIG. 18 shows the screen requiring picking out the coax.

FIG. 19 shows the relevant help screen to determine coax illumination.

FIG. 20 shows the screen to pick out the coax.

FIG. 21 shows the screen to pick out the adapter modifier, after checking the help section.

FIG. 22 shows the screen to pick out the adapter.

FIG. 23 shows the screen on which the central station confirms the correct lens attachment has been selected.

FIG. 24 shows the screen on which the mount has been picked out, after consulting the relevant help section.

FIGS. 25a and 25b show the accessory page for the 12× Zoom lens.

FIGS. 26a and 26b show the final screen with all the equipment that has been selected, plus any pieces required to make the equipment work, plus all the various optical parameters of the final system as it has been configured with the prices and the option to purchase now or find a dealer.

FIGS. 27a and 27b show the page or screen for a second example of the preferred embodiment of the invention, showing the user's initial inputs where the user wants to use the Zoom 7000 series of Navitar lenses.

FIGS. 28a and 28b show the page and screen where the Optical Wizard informs the user that his inputs will not work, and gives an explanation showing the probable cause.

FIGS. 29a and 29b show the page and screen where the user, pursuant to the information on the page of FIGS. 28a and 28b, revises his input for the working distance from 400 mm to 300 mm.

FIG. 30 shows the page or screen advising the user that there is now a solution and provides the details.

FIG. 31 is a summary page of the transaction giving the user the option to purchase online or locate a dealer.

### DETAILED DESCRIPTION OF THE PREFERRED EMBODIMENT

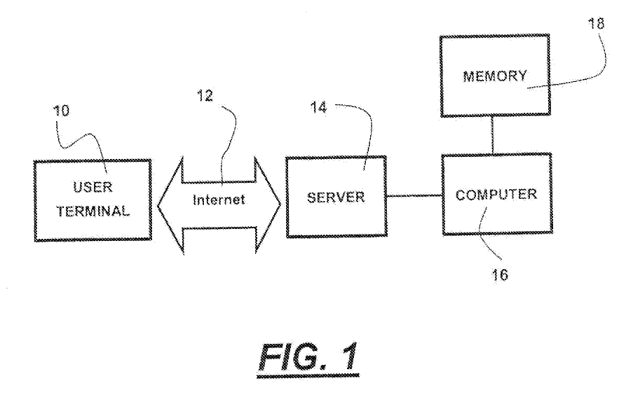

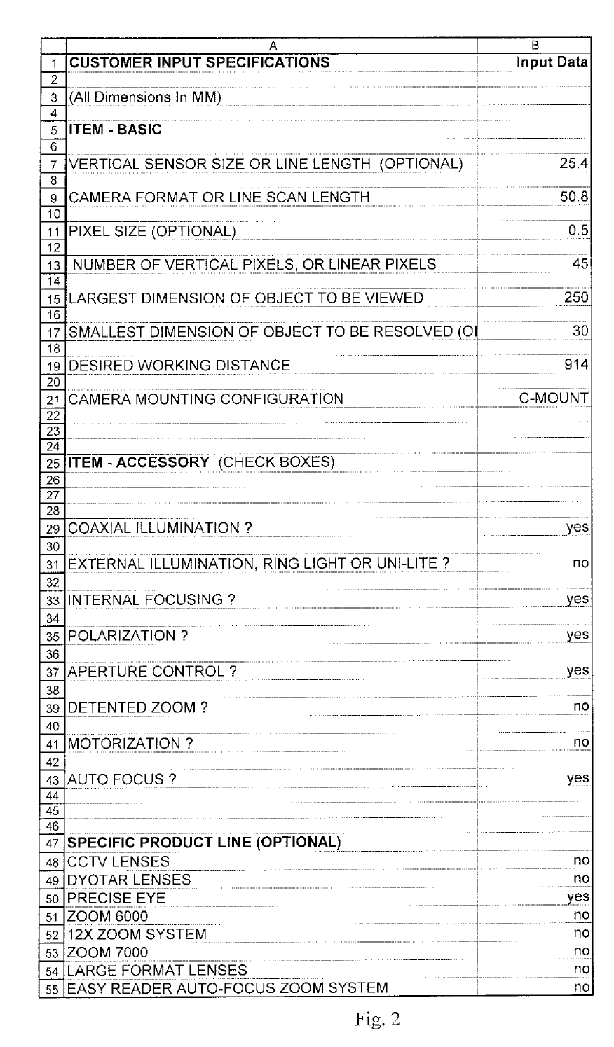

Referring first to FIG. 1, the present invention broadly relates to an automated method for selecting an optical system for a user or customer that meet the user's specifications or requirements for a particular application, such as, for example, a machine vision system used to perform an inspection process. In the preferred embodiment, the user is located at a remote user site and inputs the user specifications using a terminal 10 which may comprise a computer or other appliance capable of inputting data and transferring the data through the internet 12 to a server 14 at the user's website location. The user inputs the data into a later discussed data input table (FIG. 2) which has fixed data input fields into which the user input data defining the user's specifications for the optical system.

The server 14 routes the user specified data to a remote site data processor in the form of a computer 16 which is programmed with a set of instructions that are used to carry out the automated optical design process. The computer 16 includes a data storage system which may include one or more suitable memories 18 used to store the programmed instructions, as well as later discussed data defining the optical characteristics of a plurality of standardized optical components such as lenses, illumination sources, camera mounts, and the like. The data input table may also be stored in the memory 18. As will be discussed later, the computer 16 analyzes the user's specifications for the desired optical system and selects a combination of standard optical elements which, in combination, function to meet or substantially meet the customer's requirements. Where the resulting optical system does not exactly meet the customer's requirements, at least two optical systems will be suggested to provide the user with a choice of two systems that essentially bracket the customer's requirements. In other words, two optical systems are suggested that each nearly meet the customer's requirements, giving the customer a choice between either of these systems.

From the foregoing, it may be appreciated that the system shown in FIG. 1 is entirely automated after the user inputs his application requirements or specifications. Moreover, because the process is automated, the user is provided with essentially immediate feedback of the system. Further, because the algorithms used by this automated process are preprogrammed, the method will reliably and repeatably design a specific optical system for a given set of input specifications, thus obviating subjective design decision making which may possibly accompany a manual design processes that relies on human beings to make design decisions.

### Customer Interface

Generally, the selection process begins with the user or customer initially interfacing with automated system, as generally mentioned above. As the first step in this interface process, the customer inputs data into a customer input form shown in FIG. 1 which will be discussed later in more detail. If the customer wishes to specify a specific product line, the optical designer will automatically select the equipment compatible with the customer's input parameters and display the customer's options. Alternatively, however, the customer may request the automated optical designer to search its entire product line for possible matches. Many customer applications involve imaging a specified object size onto a sensor with a specified working distance. If a zoom system is involved, an attempt is made to cover the object at low magnification and provide a maximum ability to “zoom up” to see finer detail. Usually, the resolving of the fine detail is limited by the ability of the system to overlay the fine detail onto 2 pixels of the sensor (thereby resolving it).

Most sensors are rectangular with varying aspect ratios, or linear arrays of pixels. To eliminate any confusion associated with orientation of object vs. orientation of sensor, the smaller dimension (usually vertical) is used as the framing dimension. If conditions are such that the imaging of the object is marginal, and the customer's sensor is rectangular, the customer is given the option of receiving a small amount of extra coverage by orienting the object horizontally. In some cases, the selected optical components will not exactly match the desired parameters of working distance and field coverage, thus the optical system designer will offer a “bracketing” pair of solutions to choose from.

The normal output of the automated selection system includes the suggested equipment, along with its respective field coverage, working distance, and camera resolve limit at the specified working distance. If a zoom is involved, the working magnification and maximum available magnification and the camera resolve limit at maximum magnification will also be provided.

Reference is now made to FIG. 2 which shows a typical table used by the customer to input his specifications. The customer's input specifications are listed by line number (1-55) in column A, and fall into 3 categories: basic information, accessory information, and specific company product lines. Column B shows an example of data for a typical user application which has been input by the customer for each of the specification categories in column A.

The categories of information or data to be input by the user as shown in FIG. 2 are self-explanatory and well understood by optical designers of ordinary skill in the art, consequently, they need not be discussed in detail herein. Broadly however, the data required to be input on lines 7-21 relate to the characteristics of user's camera or imaging sensor, and those of the object to be imaged by the system. Lines 29-43 relate to possible accessories that are required by the user to meet the requirements of a particular application, such as specific types of illumination, the requirement for polarization, aperture control, motor control or automated focus. Lines 48-55 relates to specific groups or families of products offered by the optical design company. Where the user is familiar with these families of products, he may specify them, in which case the automated design process selects optical components within the specified product family to design the user's optical system

### Optics Selection Sequence

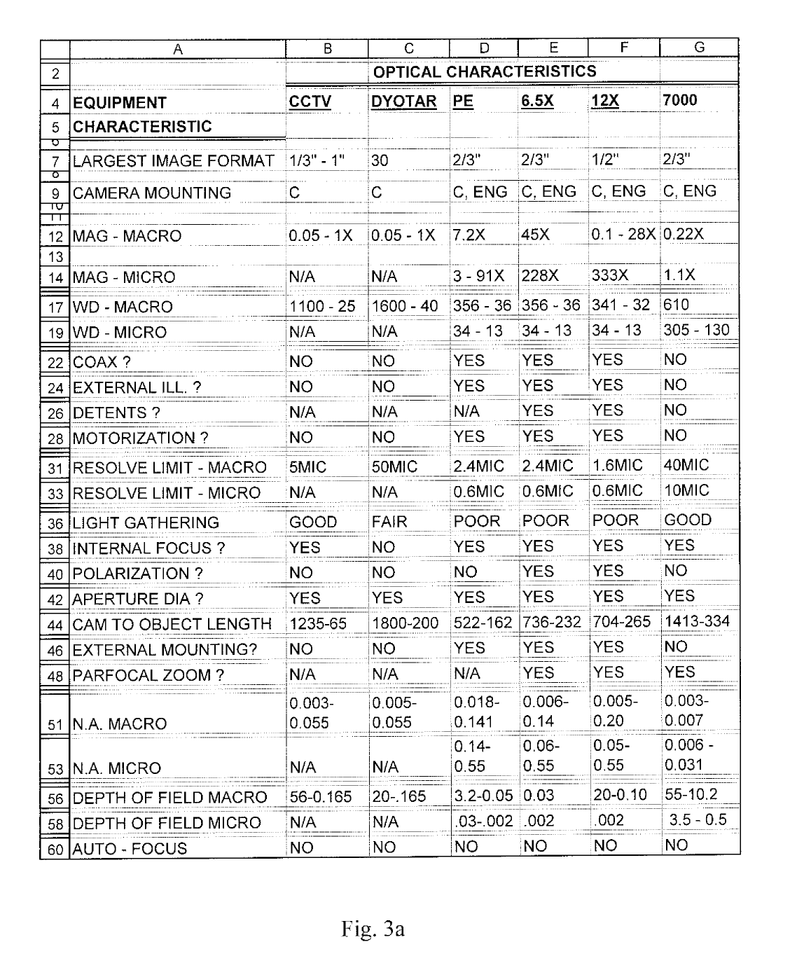

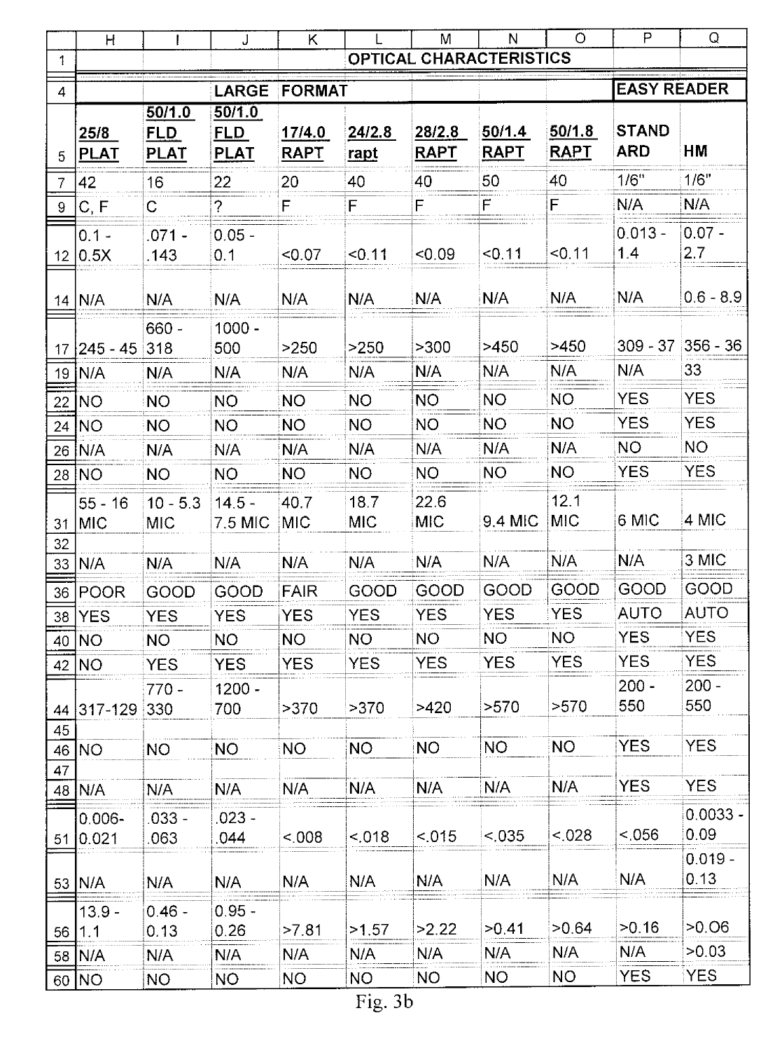

Reference is now also made to FIGS. 3A and 3B which, taken together, form a table showing the optical and equipment characteristics for each of a plurality of optical components that may be selected to “build” an optical system meeting a customer's requirements. The optical components used to build a system are given by name on lines 4 and 5. The characteristics of each of these components are given in column A, and the specific values of the characteristics for each component are given in columns B-Q. It should be noted here that the particular components and characteristic values shown in FIGS. 3A and 3B are merely illustrative of one set of possible components. Many other optical components and characteristics and or values may be used.

The following instruction set is a sequence of operations or instructions in lay terms, for making the selection of the components shown in table of FIGS. 3A and 3B, using the user input information shown in FIG. 2. These instructions may be used as an outline to develop the specific software instructions used to program the computer 16 (FIG. 1) that automatically carries out the selection process.

As used in the following sequenced instructions, “ci” refers to customer input table (FIG. 1), “oc” refers to the optical characteristics table (FIGS. 2A and 2B), and “os” refers to the current optical selection instructions. Brand or generic names of optical components or systems are used merely for illustration.

Begin-ci7, use vertical dimension if entered

If ci7 is blank, use ci9, camera format entering requires lookup table for appropriate vertical dimension

If ci11 is filled in, use it

If ci11 is blank, go to ci13 and divide the vertical sensor dimension (os1) or (os2) by the number of vertical pixels to get pixel size

Divide the number in ci15 into the vertical sensor dimension to get the required magnification

If ci17 is filled in, calculate the “resolution N.A.”=1/(3000*ci17)

Check to see that os4*2<ci17*os5. If not, report that “resolution requirement is not compatible with total field coverage and camera pixel size. The options are to reduce field coverage, decrease pixel size, or utilize a zoom system”.

Scan ci48-ci55. If any boxes are checked go directly to the appropriate product line column in oc and follow the appropriate instructions in os:

mci48-ocB, ci49-ocC, ci50-ocD, ci51-ocE, ci52-ocF, ci53-ocG, ci54-ocH thru ocN, ci55-ocO thru ocP.

If none of the above boxes are checked it will be necessary to scan all product line columns.

If ci17 is filled in, scan oc51 and oc53 for matches with resolution N.A>(os6)

Scan oc7 for matching camera formats or sensor size (os1 or os2)

Scan oc9 for matching camera mounting

Scan oc12 and oc14 for matching mag range (os5)

Scan oc17 and oc19 for matching wd range (ci19)

Scan oc22 To match ci29

Scan oc24 to match ci31

Scan oc38 to match ci33

Scan oc40 to match ci35

Scan oc42 to match ci37

Scan oc26 to match ci39

Scan oc28 to match ci41

Scan oc60 to match ci43

If no columns are a match, provide error message stating mismatch requirements for each column

If any columns in oc completely match, proceed to search for specific the equipment that will meet (or bracket) the customer requirements, and provide the customer with information explaining the “tradeoffs” between bracketing conditions.

### CCTV Lenses

If ocB is a match, run the cctv calculator to see if there is a pair of lenses that bracket the mag (os5) and working distance (ci19).

Calculate the camera resolve limit at the object=2*os4/os5.

Report the final equipment requirements, field coverage (ci15), and bracketing wd's, for each case.

Report the camera resolve limit

Show a representative picture of the equipment (with rough dimensions)

Report the price of the recommended equipment.

### Dyotar Lenses

If ocC is a match, run the dyotar calculator for a pair of lenses that bracket the mag (os5) and working distance (ci19).

Calculate the camera resolve limit at the object=2*os4/os5.

Report the final equipment requirements, field coverage, and bracketing wd's, for each case.

Report the resolve limit

Show a representative picture of the equipment (with rough dimensions)

Report the price of the recommended equipment.

### PE

If ocD is a match, you will be scanning the PE lookup tables (standard and ultra) for matches or bracketing. There is no special table for the coax version.

Start with the standard lookup table.

Scan lens attachments for a pair that brackets wd (ci19)

For each lens attachment, scan adapters for desired mag (os5). Select the condition where the listed mag<(os5).

For each bracketing condition, calculate field coverage=os2/listed mag

Calculate the lens resolve limit using the NA of the lens attachment in each bracketing case=1/(3000*NA)

Calculate the camera resolve limit in each bracketing case=2*os4/listed mag.

Report suggested equipment, wd, field coverage, camera resolve limit, and lens resolve limit in each case.

Go to the ultra lookup table.

Repeat the above steps using objectives instead of lens attachments.

If both standard and ultra equipment can apply, report on both sets of equipment.

Show a representative picture of the equipment (with rough dimensions)

Report the price of the recommended equipment.

### Zoom 6000

if ocE is a match, scan the 6.5 lookup tables (standard and ultra) for matches or bracketing. There will be one table for “standard” zoom, one table for “standard zoom with coax”, and one table for “ultra-zoom”. Do not scan “standard zoom” table if coax (ci29)=yes.

6.5 standard lookup table—

Scan the tables for lens attachments that bracket the wd (ci19).

Scan the adapters columns for matching mag (os5) range. In each case choose the adapter with the “lower mag” range<os5 and with the least difference from os5. Do not use the 5× adapter unless the working mag (os5) is greater than half way thru the next lower adapter's mag range.

Calculate the zoom settings (ZS) to produce os5 in each of the bracketing conditions=os5/(LA mag*ADAPT mag).

Calculate the working N.A. (N.A.W.) for each bracketing condition=[0.026*Ln(ZS)+0.032] [LA mag].

Calculate the working lens resolve limit=1/(3000*N.A.W.) for each bracketing condition.

Calculate the working camera resolve limit=2*os4/os5

Calculate the full mag value=4.5*LA*ADAPT

Calculate the full mag lens resolve limit=1/[3000*0.071*LA]

Calculate the full mag camera resolve=2*os4/full mag

Report, for both bracketing conditions, the equipment selected, wd, working field coverage (ci15), working camera resolve limit, working lens resolve limit, system mag at selected zoom position (os5), highs and lows of available system mag, full mag lens resolve limit and full mag camera resolve limit.

If any of the final equipment includes the 5× Adapter, go to the 12× column (ocF) and scan for suitable equipment. Report this equipment as an alternative with the notation that “Because of excessive empty magnification and light loss, we do not recommend usage of the 5× Adapter if a suitable alternative is available”.

Show a representative picture of the equipment (with rough dimensions)

Report the price of the recommended equipment.

6.5 standard lookup table w/coax—this table is similar to the plain standard table referred to above. There are fewer available lens attachments and there is a restriction on adequate illumination at lower system mags. The available mags are also a function of camera format (ci9).

Scan the tables for lens attachments that bracket the wd (ci19).

Scan the adapters columns and applicable camera format rows for matching mag (os5) range. In each case choose the adapter with the “lower mag” range<os5 and with the least difference from os5. Do not use the 5× adapter unless the working mag (os5) is greater than half way thru the next lower adapter's mag range.

Calculate the zoom settings (ZS) to produce os5 in each of the bracketing conditions=os5/(LA mag*ADAPT mag).

Calculate the working N.A. (N.A.W.) for each bracketing condition=[0.026*Ln(ZS)+0.032][LA mag].

Calculate the working lens resolve limit=1/(3000*N.A.W.) for each bracketing condition.

Calculate the working camera resolve limit=2*os4/os5

Calculate the full mag value=4.5*LA*ADAPT

Calculate the full mag lens resolve limit=1/[3000*0.071*LA]

Calculate the full mag camera resolve=2*os4/full mag

Report, for both bracketing conditions, the equipment selected, wd, working field coverage (ci15), working camera resolve limit, working lens resolve limit, system mag at selected zoom position (os5), highs and lows of available system mag, full mag lens resolve limit and full mag camera resolve limit.

If any of the final equipment includes the 5× Adapter, go to the 12× column (ocF) and scan for suitable equipment. Report this equipment as an alternative with the notation that “Because of excessive empty magnification and light loss, we do not recommend usage of the 5× Adapter if a suitable alternative is available”.

Show a representative picture of the equipment (with rough dimensions)

Report a price for the recommended equipment.

6.5 ultra-zoom lookup table

select the objectives that bracket the resolve NA (os6)

calculate the high mag required for the smallest object dimension (ci17) to cover 2 pixels=2*ci11/ci17

in the applicable camera format (ci9) row, select the lowest adapter who's upper mag limit exceeds the high mag requirement

If the low mag limit of the adapter selected is larger than os5 use it as the working mag, if smaller, use os5 as the working mag. Calculate the working zoom setting ZSW=2*working mag/(objective mag*adapter mag)

Calculate working NA (NAW) from the following:

NA (6000 ULTRA)

W/2× mit obj=0.0251*Ln(ZS)+0.0317 &=0.055 for ZS>2.21

W/5× mit obj=0.0627*Ln(ZS)+0.0791 &=0.14 for ZS>2.46

W/10× mit obj=0.1205*Ln(ZS)+0.1564 &=0.28 for ZS>2.7

W/20× mit obj=0.209*Ln(ZS)+0.3007 &=0.42 for ZS>1.72

W/50× mit obj=0.55

Calculate the working field coverage=os2/working mag

Calculate the working lens resolve limit@NAW,=1/3000*NAW

Calculate the working camera resolve limit=2*os4/working mag

calculate the full system mag=(4.5)(objective mag/2) (adapt)

calculate the maximum lens resolve limit=1/(3000*NA) where the NA's are the extremes from the above equations

calculate the maximum camera resolve limit=2*os4/full system mag

Report, for both bracketing conditions, the equipment selected, wd, working field coverage , working camera resolve limit, working lens resolve limit, working system mag, highs and lows of available system mag, full mag lens resolve limit and full mag camera resolve limit.

Show a representative picture of the equipment (with rough dimensions)

Report a price for the recommended equipment.

### 12× Zoom System

If ocF is a match, scan the 12× lookup tables (standard and ultra) for matches or bracketing. There will be one table for “standard” zoom, one table for “standard zoom with coax”, and one table for “ultra-zoom”. Do not scan “standard zoom” table if coax ci29=yes.

Standard 12× Lookup Table

scan the tables for lens attachments that bracket the wd (ci19).

In each case choose the adapter with the “lower mag” range<os5 and with the least difference from os5.

Calculate the zoom settings (ZS) to produce os5 in each of the bracketing conditions=os5/(LA mag*ADAPT mag).

Calculate the working N.A. (N.A.W.) for each bracketing condition=[0.000328(ZS)³−0.005274(ZS)²+0.035318(ZS)+0.000965] [LA mag]

Calculate the working lens resolve limit=1(3000*N.A.W.) for each bracketing condition.

Calculate the working camera resolve limit=2*os4/os5

Calculate the full mag value=7.0*LA*ADAPT

Calculate the full mag lens resolve limit=1/[3000*0.1*LA]

Calculate the full mag camera resolve=2*os4/full mag

Report, for both bracketing conditions, the equipment selected, wd, working field coverage (ci15), working camera resolve limit, working lens resolve limit, system mag at selected zoom position (os5), highs and lows of available system mag, full mag lens resolve limit and full mag camera resolve limit.

Show a representative picture of the equipment (with rough dimensions)

Report a price for the recommended equipment.

12× standard lookup table w/coax—this table is similar to the plain standard table referred to above. There are fewer available lens attachments and there is a restriction on adequate illumination, at lower system mags.

scan the tables for lens attachments that bracket the wd (ci19).

In each case choose the adapter with the “lower mag” range<cos5 and with the least difference from os5.

Calculate the zoom settings (ZS) to produce os5 in each of the bracketing conditions=os5/(LA mag*ADAPT mag).

Calculate the working N.A. (N.A.W.) for each bracketing condition=

[0.000328(ZS)³−0.005274(ZS)²+0.035318(ZS)+0.000965] [LA mag]

Calculate the working lens resolve limit=1/(3000*N.A.W.) for each bracketing condition

Calculate the working camera resolve limit=2*os4/os5

Calculate the full mag value=7.0*LA*ADAPT

Calculate the full mag lens resolve limit=1/[3000*0.1*LA]

Calculate the full mag camera resolve=2*os4/full mag

Report, for both bracketing conditions, the equipment selected, wd, working field coverage (ci15), working camera resolve limit, working lens resolve limit, system mag at selected zoom position (os5), highs and lows of available system mag, full mag lens resolve limit and full mag camera resolve limit.

Show a representative picture of the equipment (with rough dimensions)

Report the price of the recommended equipment.

12× ultra-zoom lookup table

select the objective based on resolve NA (os6)

calculate the high mag required for the smallest object dimension (ci17) to cover 2 pixels=2*ci11/ci17

In the applicable camera format (ci9) row, select the lowest adapter who's upper mag limit exceeds the high mag requirement

If the low mag limit of the adapter selected is larger than os5 use it as the working mag, if smaller, use os5 as the working mag.

Calculate working zoom setting ZSW=[(0.95185*ZS)/2] (obj mag) (adapt)

Calculate working NA (NAW) from the following:

NA (12× ULTRA)

W/2× mit obj=0.0271*Ln(ZS)+0.0316 &=0.055 for ZS>2.25

W/5× mit obj=0.0667*Ln(ZS)+0.0786 &=0.14 for ZS>2.24

W/10× mit obj=0.1293*Ln(ZS)+0.1553 &=0.28 for ZS>2.25

W/20× mit obj=0.2222*Ln(ZS)+0.2953 &=0.42 for ZS>1.7

W/50× mit obj=0.3543*Ln(ZS)+0.6062 & 0.55 for ZS>0.8

Calculate the working field coverage=os2/working mag

Calculate the working lens resolve limit@NAW,=1/3000*NAW

Calculate the working camera resolve limit=2*os4/working mag

Calculate the full system mag=(7.0)(objective mag/2) (adapt)

Calculate the maximum lens resolve limit=1/(3000*NA) where the NA's are the extremes from the above equations

Calculate the maximum camera resolve limit=2*os4/full system mag

Report, for both bracketing conditions, the equipment selected, wd, working field coverage , working camera resolve limit, working lens resolve limit, working system mag, highs and lows of available system mag, full mag lens resolve limit and full mag camera resolve limit.

Show a representative picture of the equipment (with rough dimensions)

Report a price for the recommended equipment.

### Zoom 7000

If ocG is a match,

Based on desired wd (ci19), select micro or macro mode.

Calculate the low working mag (lwmag) at (ci19)

Micro, lwmag=(48.332)*(wd^{-1.153})

Macro, lwmag=(53.284)*(wd^{-1.1362})

Calculate the high working mag (hwmag) at (ci19)=6*lwmag

Calculate the field coverage at both low and high mag=os2/wmag

Calculate the camera resolve limit at both low and high mag=2*os4/wmag)

Calculate the low xwd (lxwd) at the desired mag (os5)

Micro, lxwd=^{1.153}√(48.332/os5)

Macro, lxwd=^{1.1362}√(53.284/os5)

Check that lxwd falls between 1219-610, or 305-130, if not pick the closest end value in the original selected mode and use it as lxwd.

If the calculated lxwd was not available, recalculate the mag at the revised position

Micro, lxmag=(48.332)*(lxwd^{-1.153})

Macro, lxmag=(53.284)*(lxwd^{-1.1362})

Calculate the high mag (hxmag)=6*lxmag

Calculate the field coverage at both low and high mag=os2/xmag

Calculate the camera resolve limit at both low and high mag=2*(os4/xmag)

For the desired working distance (ci19), report the field coverage at both low and high mag positions (lwmag) and (hwmag). Also report the camera resolution limits at both low and high mag.

For the desired mag (os5), or the alternate value, report the field coverage at both low and high mag positions (lxmag) and (hxmag). Also report the camera resolution limits at both low and high mag.

Show a representative picture of the equipment (with rough dimensions)

Report the price of the recommended equipment.

Large Format

If ocH-ocO is a match,

ocH:

Determine the working mag (wmag) at the desired wd (ci19)

wmag=25/(wd+5)

Calculate the field coverage at (ci19)=os2/wmag

Calculate the camera resolve limit at (wmag)=2*(os4/wmag)

Calculate the wd (xwd) at the desired mag (os5)

xwd=(25/os5)−5

Check that xwd falls between 245-45, if not pick the closest end value and use it as nxwd.

Calculate the new magnification (nxmag) at nxwd=25/(nxwd+5)

Calculate the field coverage at nxwd=os2/nxmag

Calculate the camera resolve limit at (nxmag)=2*(os4/nxmag)

Report the field coverage at the desired working distance (ci19). Report the camera resolve limit at this position.

Report the available wd (xwd) that will have (or come closest to having) the desired field coverage Report the field coverage at this working distance. Report the camera resolve limit at this position.

Show a representative picture of the equipment (with rough dimensions)

Report a price for the recommended equipment.

ocI:

Determine the working mag (wmag) at the desired wd (ci19)

wmag=50/(wd+40)

Calculate the field coverage at (ci19)=os2/wmag

Calculate the camera resolve limit at (wmag)=2*(os4/wmag)

Calculate the wd (xwd) at the desired mag (os5)

xwd=(50/os5)−40

Check that xwd falls between 660-318, if not pick the closest end value and use it as nxwd.

Calculate the new magnification (nxmag) at nxwd=50/(nxwd+40)

Calculate the field coverage at nxwd=os2/nxmag

Calculate the camera resolve limit at (nxmag)=2*(os4/nxmag)

Report the field coverage at the desired working distance (ci19). Report the camera resolve limit at this position.

Report the available wd (xwd) that will have (or come closest to having) the desired field coverage. Report the field coverage at this working distance. Report the camera resolve limit at this position.

Show a representative picture of the equipment (with rough dimensions)

Report a price for the recommended equipment.

ocJ:

Determine the working mag (wmag) at the desired wd (ci19)

wmag=50/wd

Calculate the field coverage at (ci19)=os2/wmag

Calculate the camera resolve limit at (wmag)=2*(os4/wmag)

Calculate the wd (xwd) at the desired mag (os5)

xwd=50/os5

Check that xwd falls between 1000-500, if not pick the closest end value and use it as nxwd.

Calculate the new magnification (nxmag) at nxwd=50/nxwd

Calculate the field coverage at nxwd=os2/nxmag

Calculate the camera resolve limit at (nxmag)=2*(os4/nxmag)

Report the field coverage at the desired working distance (ci19). Report the camera resolve limit at this position.

Report the available wd (xwd) that will have (or come closest to having) the desired field coverage. Report the field coverage at this working distance. Report the camera resolve limit at this position.

Show a representative picture of the equipment (with rough dimensions)

Report a price for the recommended equipment.

ocK:

Determine the working mag (wmag) at the desired wd (ci19)

wmag=17/(wd+15)

Calculate the field coverage at (ci19)=os2/wmag

Calculate the camera resolve limit at (wmag)=2*os4/wmag)

Calculate the wd (xwd) at the desired mag (os5)

xwd=(17/os5)−15

Check that xwd>250, if not use 250 as nxwd.

Calculate the new magnification (nxmag) at nxwd=17/(nxwd+15)

Calculate the field coverage at nxwd=os2/nxmag

Calculate the camera resolve limit at (nxmag)=2*os4/nxmag)

Report the field coverage at the desired working distance (ci19). Report the camera resolve limit at this position.

Report the available wd (xwd) that will have (or come closest to having) the desired field coverage. Report the field coverage at this working distance. Report the camera resolve limit at this position.

Show a representative picture of the equipment (with rough dimensions)

Report a price for the recommended equipment.

ocL:

Determine the working mag (wmag) at the desired wd (ci19)

wmag=24/(wd+5)

Calculate the field coverage at (ci19)=os2/wmag

Calculate the camera resolve limit at (wmag)=2*(os4/wmag)

Calculate the wd (xwd) at the desired mag (os5)

xwd=(24/os5)−5

Check that xwd>250, if not use 250 as nxwd.

Calculate the new magnification (nxmag) at nxwd=24/(nxwd+5)

Calculate the field coverage at nxwd=os2/nxmag

Calculate the camera resolve limit at (nxmag)=2*os4/nxmag)

Report the field coverage at the desired working distance (ci19). Report the camera resolve limit at this position.

Report the available wd (xwd) that will have (or come closest to having) the desired field coverage. Report the field coverage at this working distance. Report the camera resolve limit at this position.

Show a representative picture of the equipment (with rough dimensions)

Report a price for the recommended equipment.

ocM:

Determine the working mag (wmag) at the desired wd (ci19)

wmag=28/(wd+5)

Calculate the field coverage at (ci19)=os2/wmag

Calculate the camera resolve limit at (wmag)=2*os4/wmag)

Calculate the wd (xwd) at the desired mag (os5)

xwd=(28/os5)−5

Check that xwd>300, if not use 300 as nxwd.

Calculate the new magnification (nxmag) at nxwd=28/(nxwd+5)

Calculate the field coverage at nxwd=os2/nxmag

Calculate the camera resolve limit at (nxmag)=2*os4/nxmag)

Report the field coverage at the desired working distance (ci19). Report the camera resolve limit at this position.

Report the available wd (xwd) that will have (or come closest to having) the desired field coverage. Report the field coverage at this working distance. Report the camera resolve limit at this position.

Show a representative picture of the equipment (with rough dimensions)

Report a price for the recommended equipment.

ocN:

Determine the working mag (wmag) at the desired wd (ci19)

wmag=50/wd

Calculate the field coverage at (ci19)=os2/wmag

Calculate the camera resolve limit at (wmag)=2*(os4/wmag)

Calculate the wd (xwd) at the desired mag (os5)

xwd=50/os5

Check that xwd>450, if not use 450 as nxwd.

Calculate the new magnification (nxmag) at nxwd=50/nxwd

Calculate the field coverage at nxwd=os2/nxmag

Calculate the camera resolve limit at (nxmag)=2*os4/nxmag)

Report the field coverage at the desired working distance (ci19). Report the camera resolve limit at this position.

Report the available wd (xwd) that will have (or come closest to having) the desired field coverage. Report the field coverage at this working distance. Report the camera resolve limit at this position.

Show a representative picture of the equipment (with rough dimensions)

Report a price for the recommended equipment.

ocO:

Determine the working mag (wmag) at the desired wd (ci19)

wmag=50/(wd+20)

Calculate the field coverage at (ci19)=os2/wmag

Calculate the camera resolve limit at (wmag)=2*os4/wmag)

Calculate the wd (xwd) at the desired mag (os5)

xwd=(50/os5)−20

Check that xwd>450, if not use 450 as nxwd.

Calculate the new magnification (nxmag) at nxwd=50/(nxwd+20)

Calculate the field coverage at nxwd=os2/nxmag

Calculate the camera resolve limit at (nxmag)=2*os4/nxmag)

Report the field coverage at the desired working distance (ci19). Report the camera resolve limit at this position.

Report the available wd (xwd) that will have (or come closest to having) the desired field coverage. Report the field coverage at this working distance. Report the camera resolve limit at this position.

Show a representative picture of the equipment (with rough dimensions)

Report a price for the recommended equipment.

Easy Reader

If ocP-Q is a match:

In this product line, the camera is built in.

Ci7=1.8 mm, therefore os2=1.8

Ci11=0.0023, therefore os4=0.0023

There are two columns, Standard and HM. The difference is in the magnification and resolution requirements.

Scan the Standard and HM lookup tables for compatible wd's and mag ranges. If both are suitable, choose the Standard, unless the resolution requirement ci17 is better matched in HM. Maximum resolution is measured at high zoom position. If ci17 is not achieved in either of the above, use the lowest power objective required to produce the resolution and offer it as an alternative.

### Standard

Pick the LA's that bracket the wd requirement ci19

Use os5 as the working mag (wmag)

Calculate the working N.A. (NAW) for each bracketing condition=(0.0414*wmag)−(0.0095*LA)

Calculate the working lens resolve limit=1/(3000*NAW) for each bracketing condition.

Calculate the working camera resolve limit=2*os4/os5

Look up the full mag value (fmag) for each condition

Calculate the full mag camera resolve=2*os4/fmag

Look up the full mag value of lens resolve limit for each condition

Report, for both bracketing conditions, the equipment selected, wd, working field coverage (ci15), working camera resolve limit, working lens resolve limit, system mag at selected zoom position (os5), highs and lows of available system mag, full mag lens resolve limit and full mag camera resolve limit.

Show a representative picture of the equipment (with rough dimensions)

Report a price for the recommended equipment.

### HM—Lens Attachment

Pick the LA's that bracket the wd requirement ci19

Use os5 as the working mag (wmag)

Calculate the working N.A. (NAW) for each bracketing condition, based on the individual formulas (per LA) in the lookup table

Calculate the working lens resolve limit=1/(3000*NAW) for each bracketing condition.

Calculate the working camera resolve limit=2*os4/os5

Look up the full mag value (fmag) for each condition

Calculate the full mag camera resolve=2*os4/fmag

Look up the full mag value of lens resolve limit for each condition

Report, for both bracketing conditions, the equipment selected, wd, working field coverage (ci15), working camera resolve limit, working lens resolve limit, system mag at selected zoom position (os5), highs and lows of available system mag, full mag lens resolve limit and full mag camera resolve limit.

Show a representative picture of the equipment (with rough dimensions)

Report a price for the recommended equipment.

### HM—Objective

If ci17 is not achieved in either of the above, use the lowest power objective required to produce the resolution and offer it as an alternative.

Calculate the working N.A. (NAW) based on the individual formulas (per OBJ) in the lookup table

Calculate the working lens resolve limit=1/(3000*NAW)

Calculate the working camera resolve limit=2*os4/os5

Look up the full mag value (fmag)

Calculate the full mag camera resolve=2*os4/fmag

Look up the full mag value of lens resolve limit

Report the equipment selected, wd, working field coverage (ci15), working camera resolve limit, working lens resolve limit, system mag at selected zoom position (os5), highs and lows of available system mag, full mag lens resolve limit and full mag camera resolve limit.

Show a representative picture of the equipment (with rough dimensions)

Report a price for the recommended equipment.

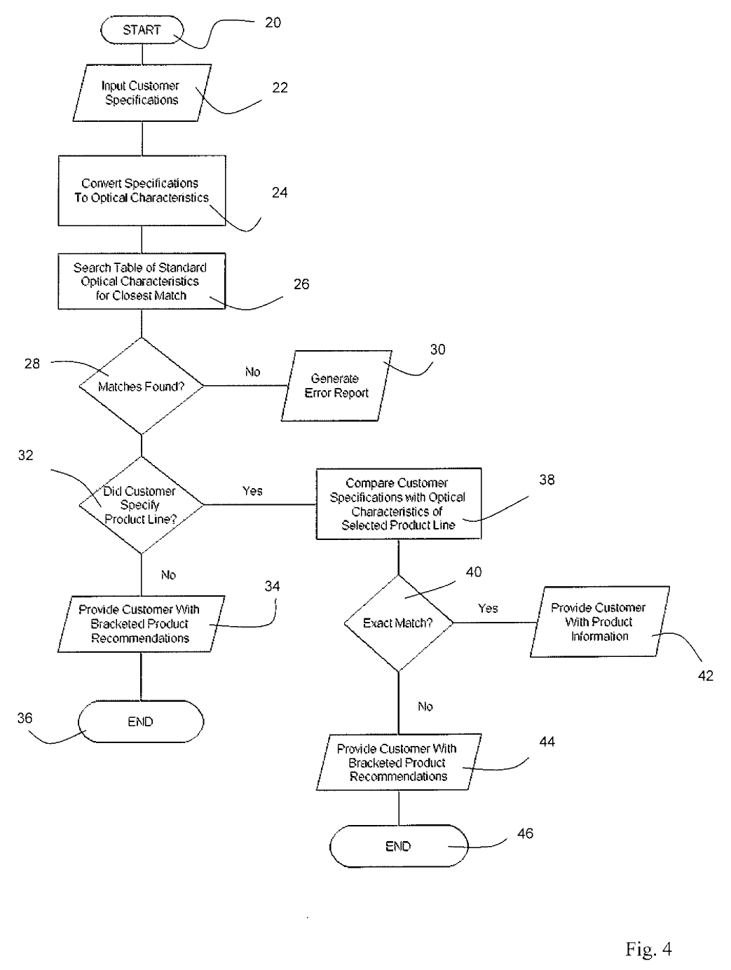

Reference is now made to FIG. 4, which shows a simplified flowchart of the basic steps of the automated design method described above. The automated method starts at 20 with the customer establishing contact with the automated design system. In the case of the preferred embodiment described above, this initial contact comprises the customer making contact with the designer's website through the internet, although this communication link could instead be established through a LAN, WAN or direct wireless link. At step 22, the customer inputs data defining the user's requirements or specifications, using the input format shown in FIG. 2. These specifications are converted to optical characteristics by the automated design system at step 24, following which the design system searches a table (FIGS. 3A and 3B) of optical characteristics to determine the closest match between an available optical component and the optical characteristic meeting the customer's specification. If a match is not found at step 28, an error report is generated at 28, otherwise, the process proceeds to step 32 where a determination is made as to whether the customer has specified a standard product line or family.

If the customer has not specified a particular product line, the customer is provided with two optical design configurations in step 34 which bracket each side of the customer's specifications, thus allowing the customer to choose between these two systems. With the system designs having been provided to the customer, the process ends at 36.

In the event that the customer specifies a product line at step 32, then a comparison is made at step 38, in which the customer's specifications are compared to the optical characteristics of the customer selected product line. If an exact match is found at 40, then the customer in step 42 is provided with full product information on the matching product line. However, if an exact match is not found, the customer is provided with bracketed product line recommendations at 44, following which the process ends at 46.

### Second Embodiment—Preferred

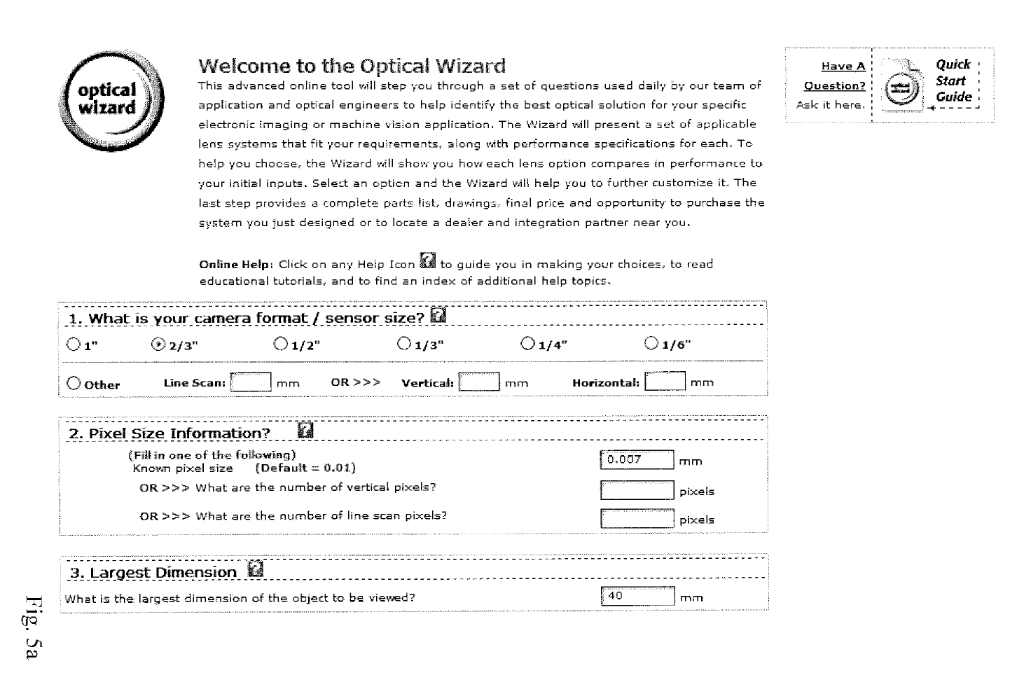

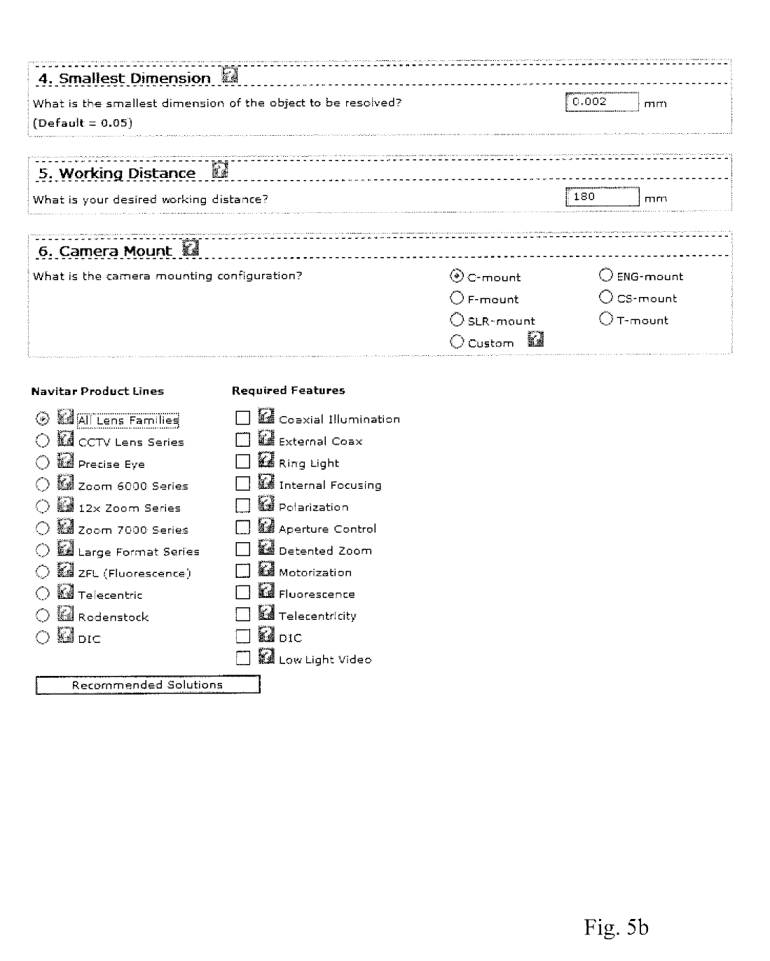

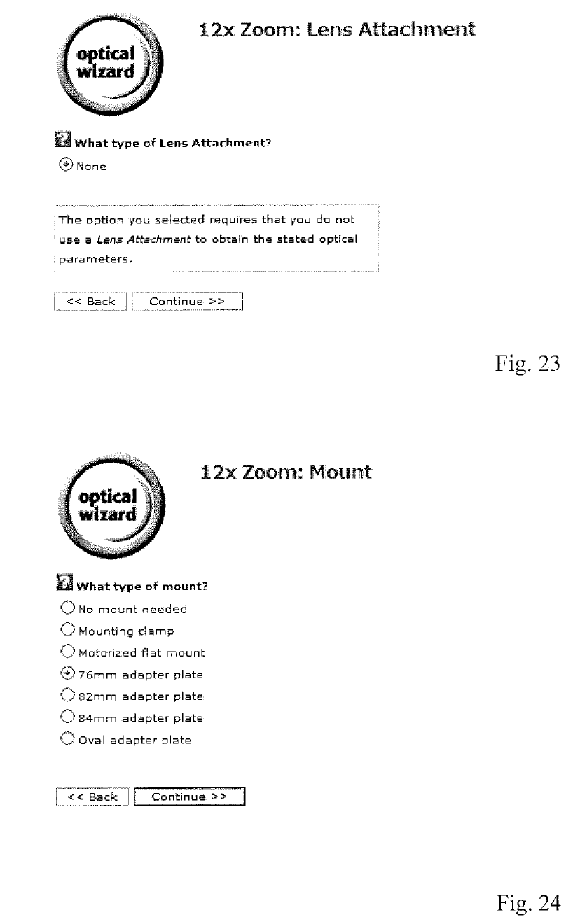

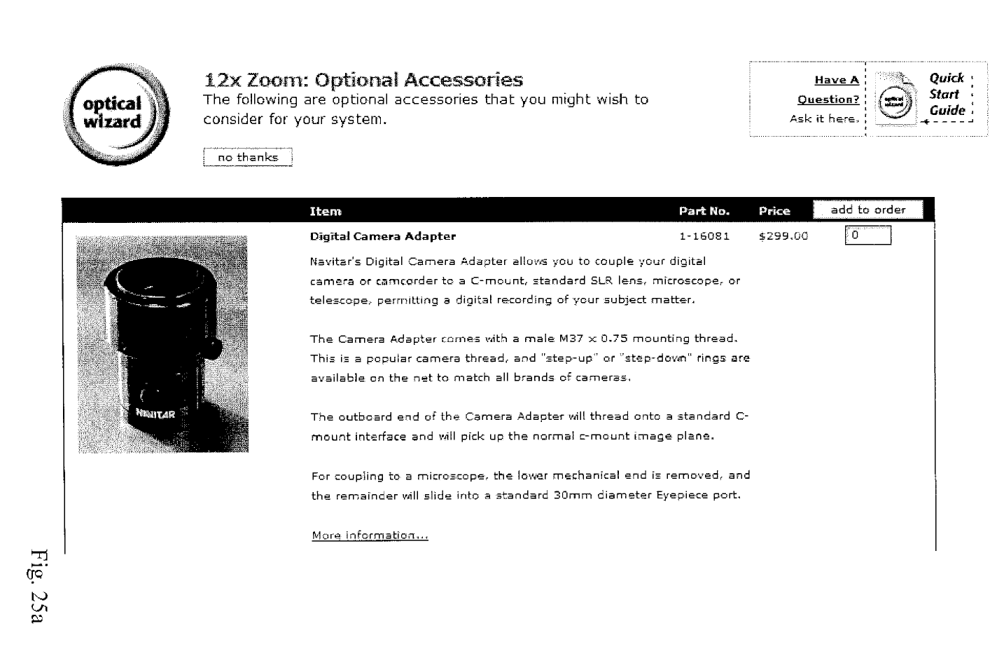

FIGS. 5a to 26b show a second embodiment of the invention, termed the Optical Wizard. This second embodiment of the invention relates to an advanced online tool in the form of a computer application (including appropriate algorithms) resident in a computer located at a central station connected to the Internet that automatically responds to a user inquiry, and thereafter, steps the user through a set of questions to identify the best optical solution for the user's specific electronic imaging or machine vision application. This designing of and engineering of a solution to the user's requirements occurs interactively and automatically in a single session via the Internet on screens or pages provided by the program, and without any intervention of a human designer or engineer. The tool presents initially a set of applicable lens options that fit the user's requirements, as expressed in the user's inputs, together with specific performance specifications for each. The application goes on to compare each lens option in performance with the user inputs. The user then selects one option, and the tool further customizes it. As a last step, the tool will provide a list of complete parts, drawings and a final price, together with an option to purchase immediately online or alternatively, to locate a dealer and integration partner convenient to the user.

There now follows an example of how the invention operates to provide a solution to a user's inputs. FIGS. 5a and 5b show the initial input screen which a user sees when initiating the Optical Wizard by clicking on the website of the company (Navitar) providing the service. This input screen is automatically sent to the user's computer, and contains six questions concerning user's requirements, i.e. camera format/sensor size, pixel size, largest dimension, smallest dimension, working distance and camera mount. Both pixel size and smallest dimension have default values. In addition, a list of products and required features is provided for ticking as desired. As seen in FIGS. 5a and 5b, user has ticked ⅔″, 0.007 mm, 40 mm, 0.002 mm, 180 mm and C-mount, and has ticked “all lens families”.

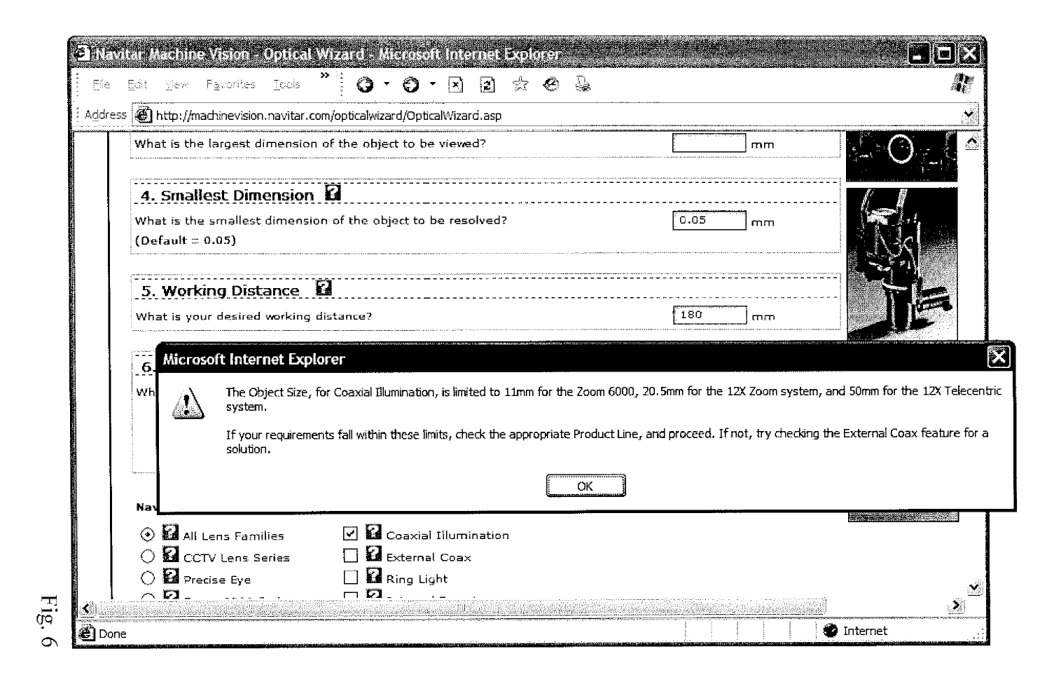

Automatically in response to the screen of FIGS. 5a and 5b, the central station sent a dialog box to user advising that, since user requested coax, his input field of view is too large. (See FIG. 6)

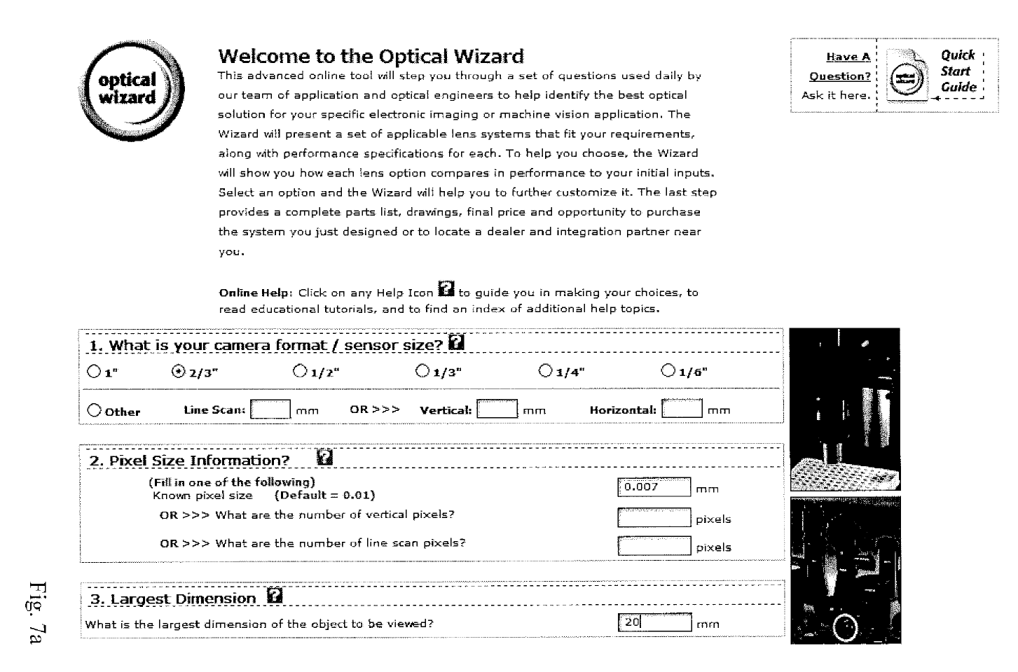

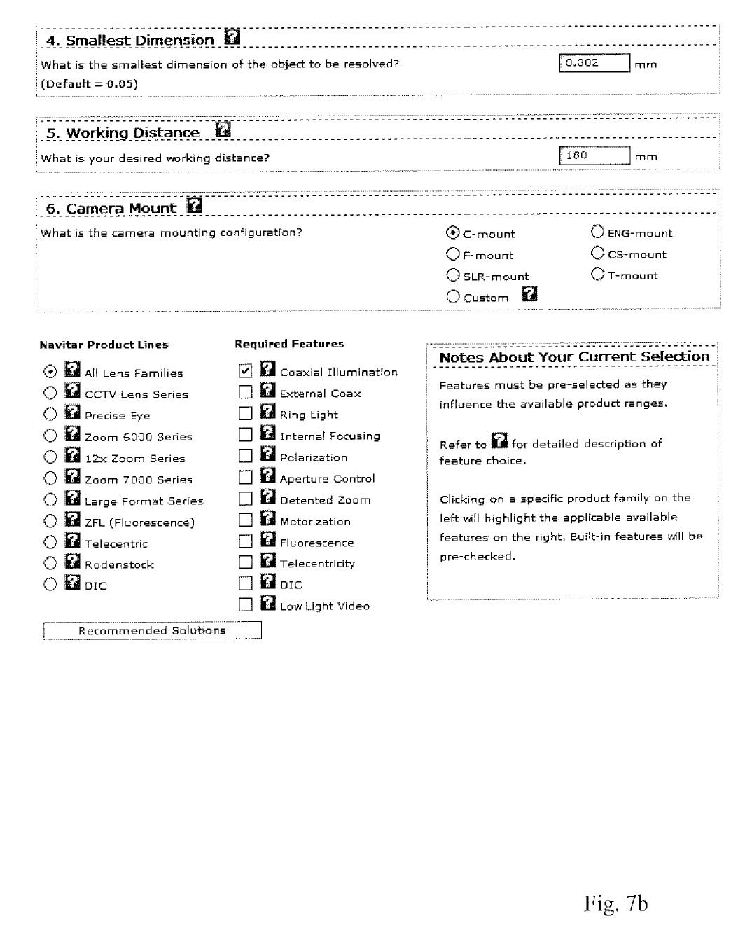

Accordingly, user in FIGS. 7a and 7b, changes inputs to reduce the largest dimension from 40 mm to 20 mm to allow use of a 12× Zoom lens.

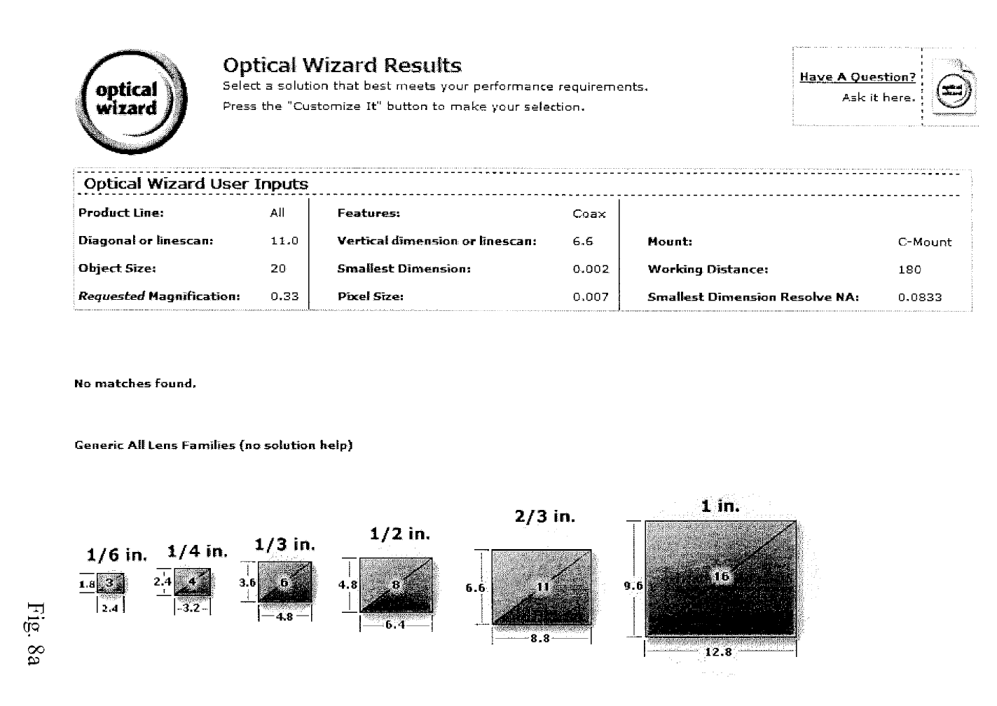

In FIGS. 8a and 8b, the central station sends a no matches found message, and an explanation of how the Wizard is checking.

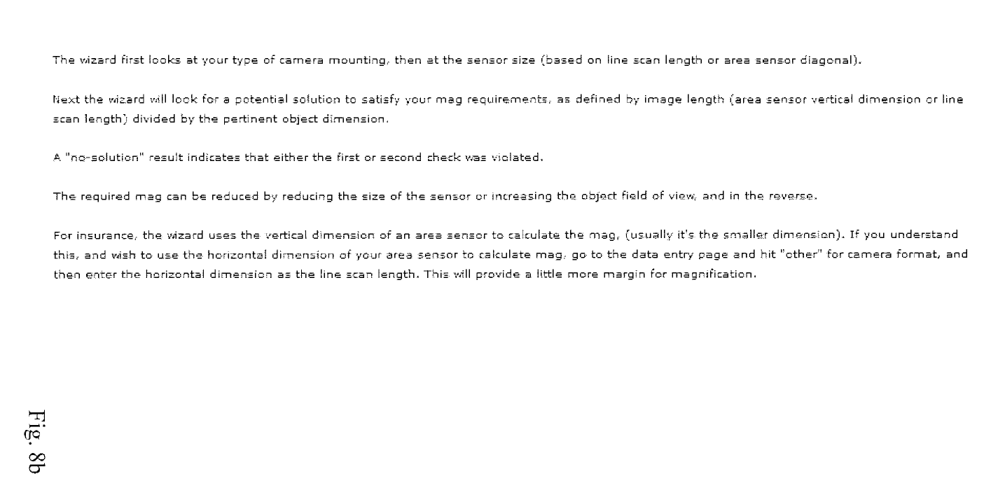

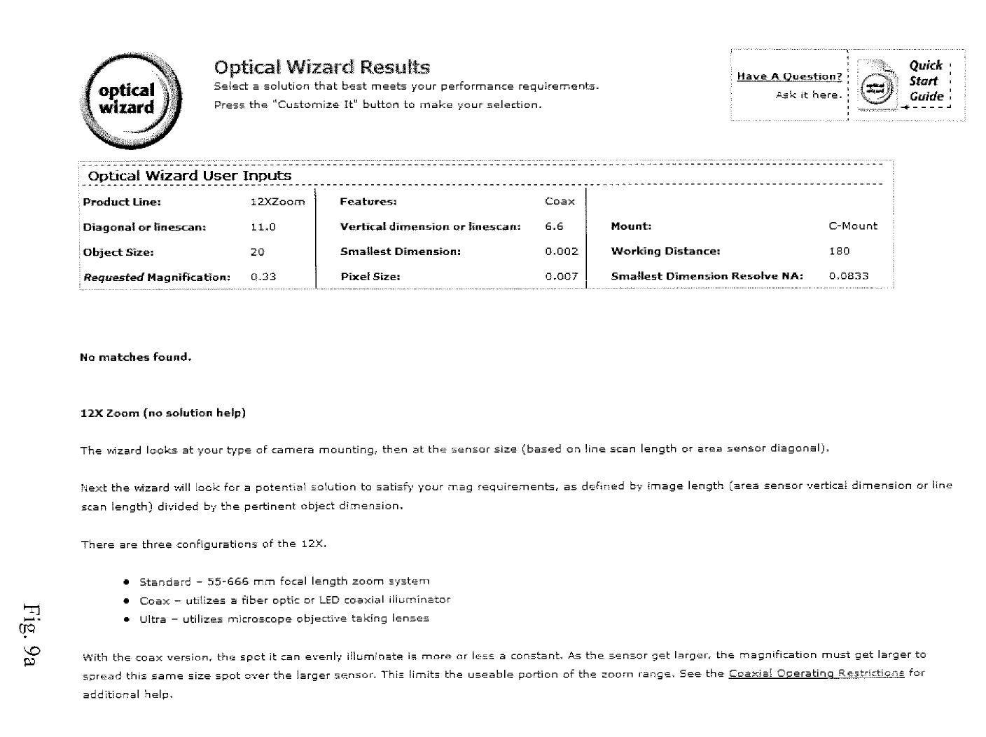

Accordingly, user changes inputs to specifically request a 12× Zoom lens solution, and in response thereto, the central station, in FIGS. 9a and 9b, sends a no matches found message, and explains in detail that the mag looks OK, but the coax does not meet restrictions.

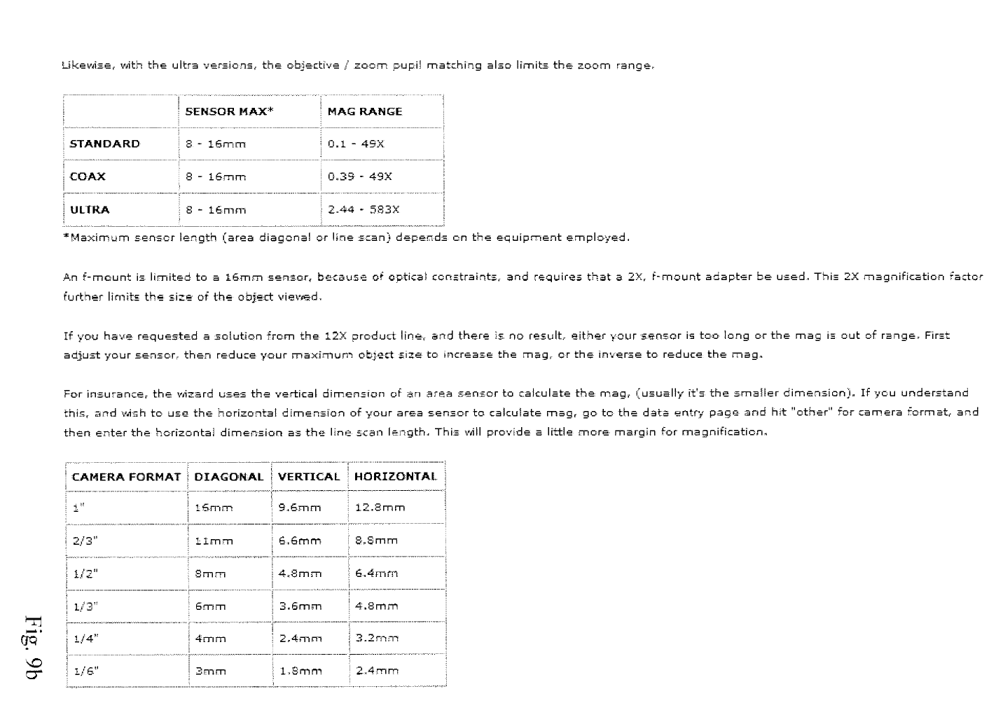

The user then checks the coax restriction, under help, and receives the help screen of FIG. 10, which explains that his filed is too large to get full illumination with a coax.

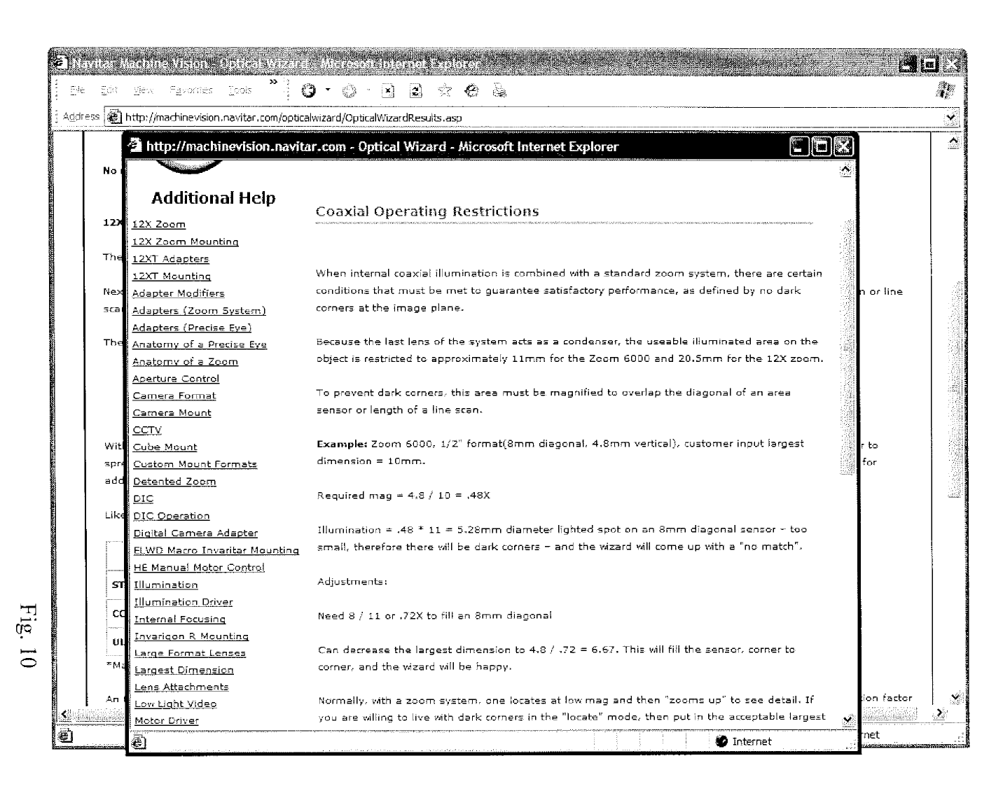

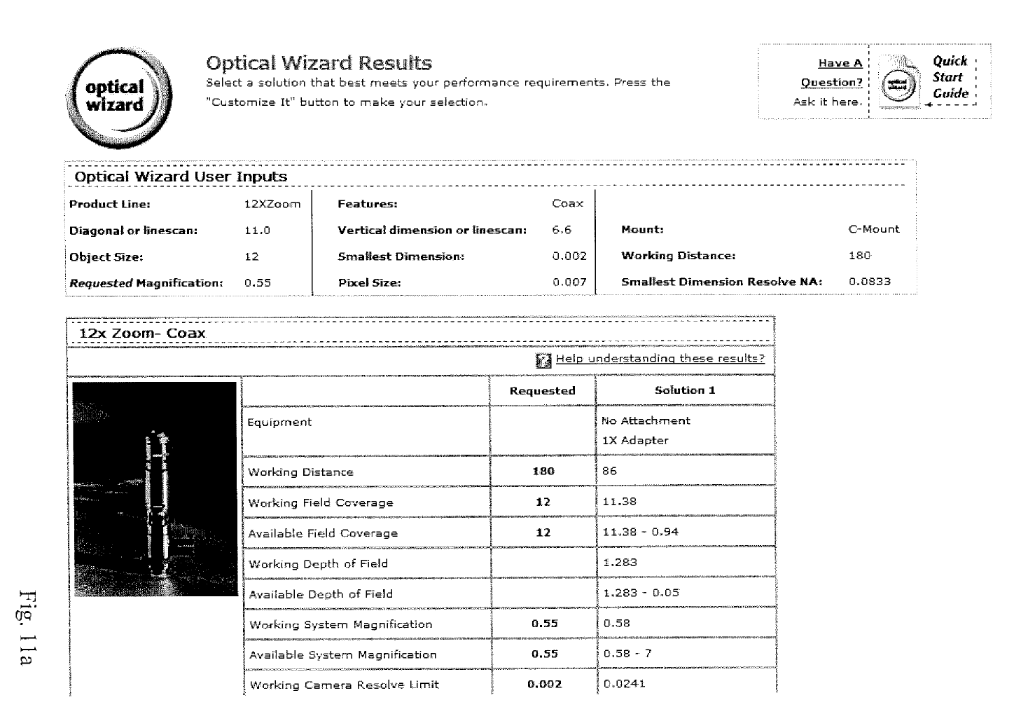

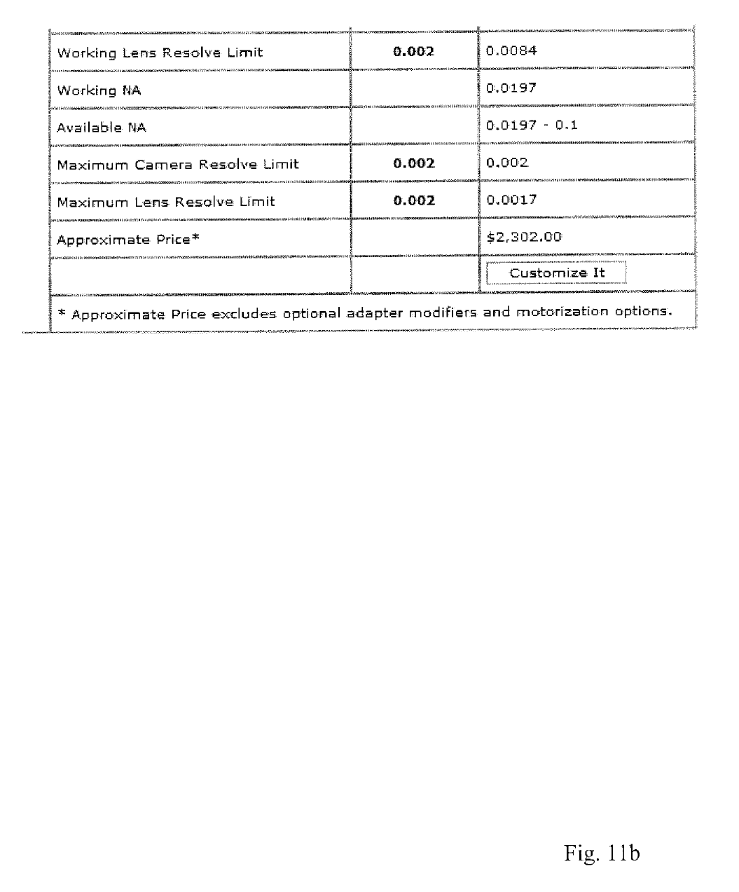

Thus, user changes his inputs to lower the field from 20 mm to 12 mm, and receives from the central station, a screen in FIGS. 11a and 11b, advising a solution, and in a screen in FIG. 12, he receives a generic picture of the final system, so user is informed in detail of the other items that must be chosen to complete the system.

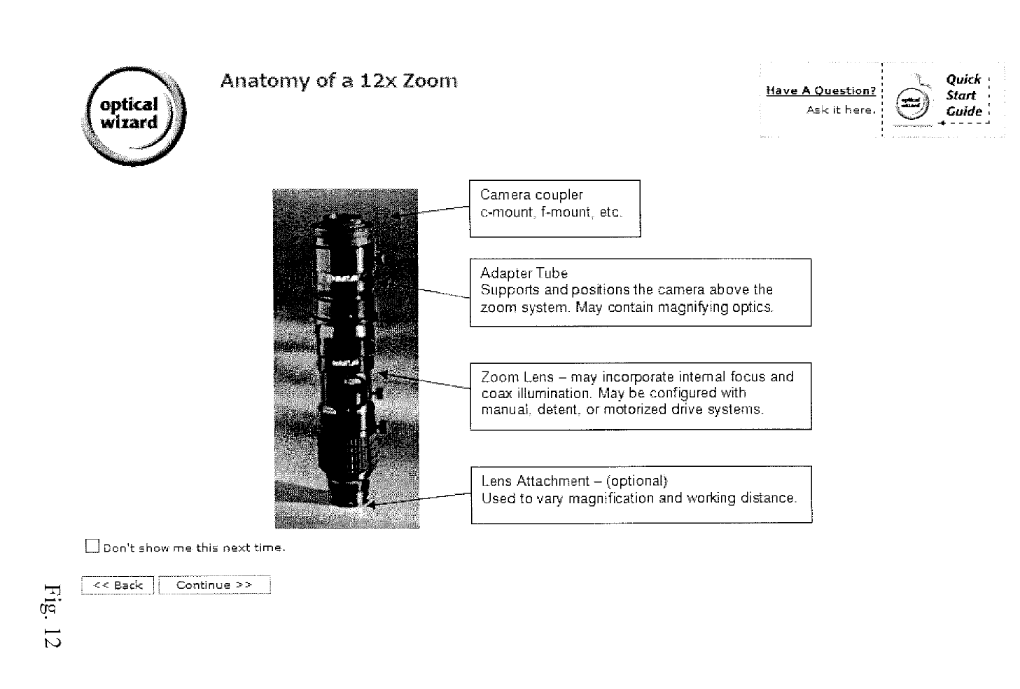

In FIG. 13, user decides he wants a motorized zoom drive, and thus, receives a screen from the central station asking “What type of zoom drive?”, and he ticks “Micromo Stepper HE”, and sends back to the central station.

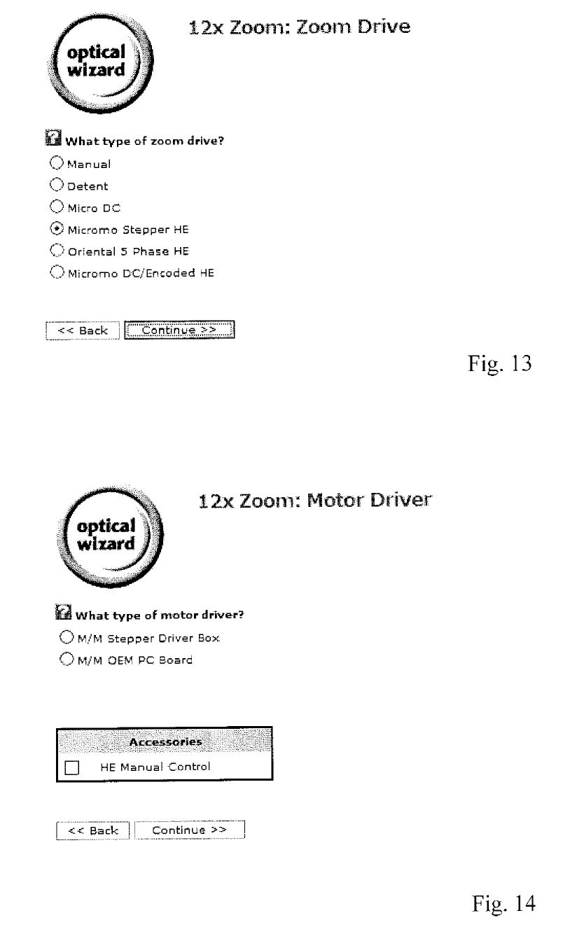

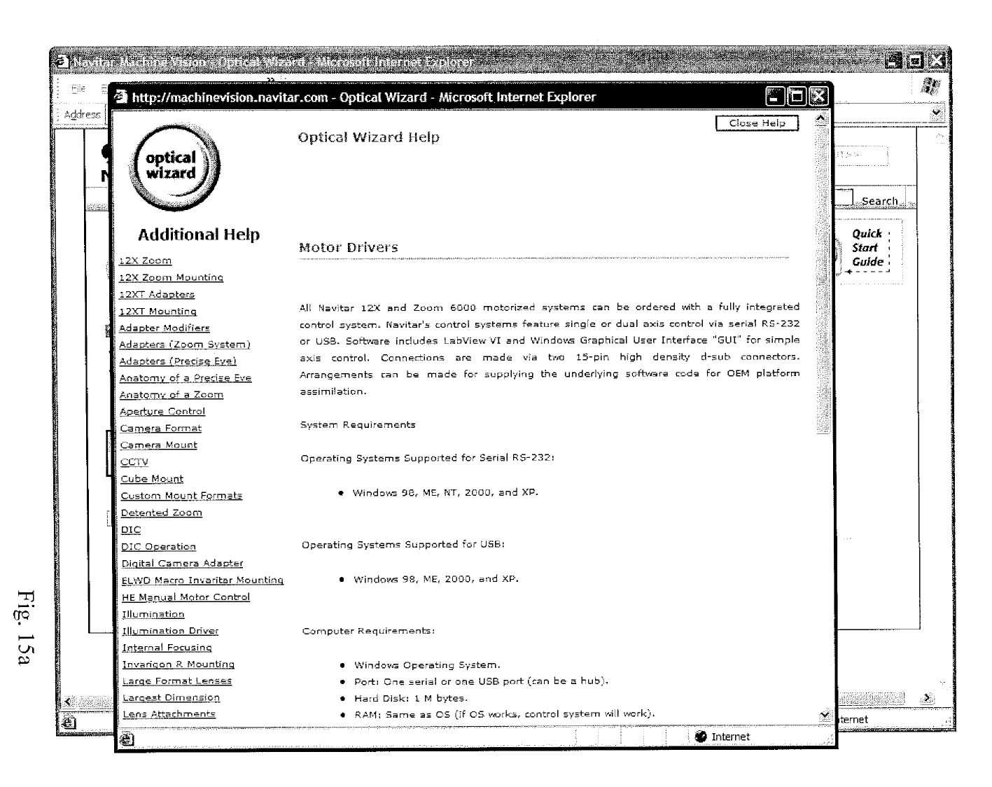

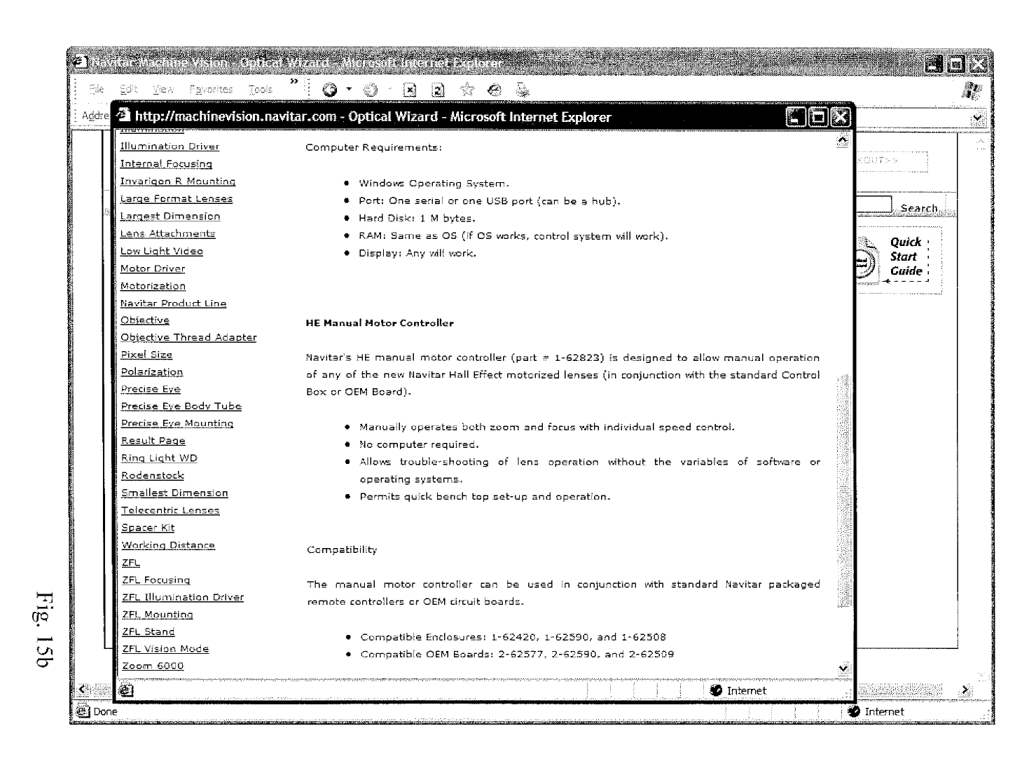

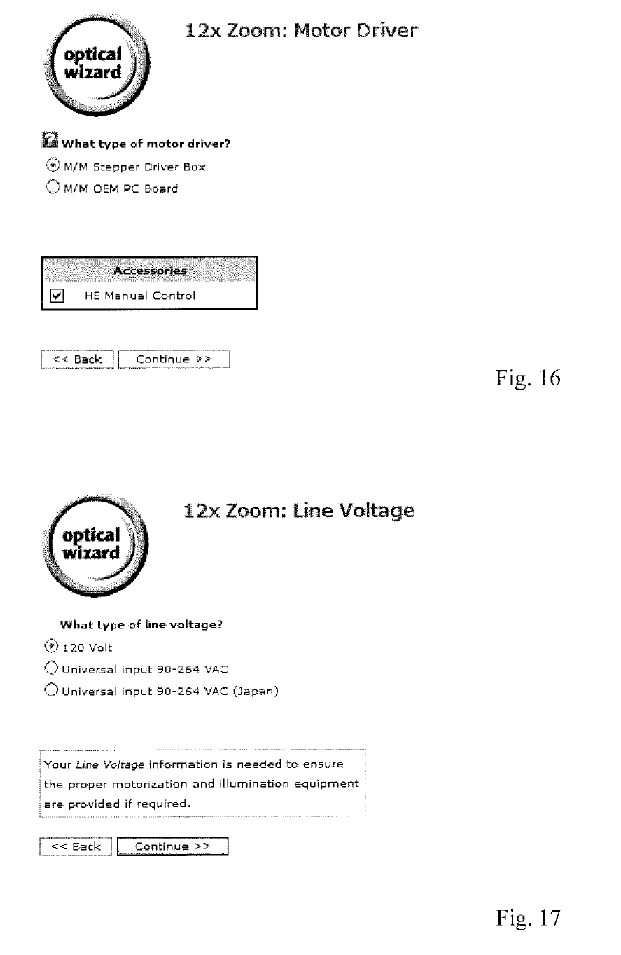

In response, the central station sends a screen, see FIG. 14, asking “What type of motor drive?”, and in response, user checks out the relevant help screen, see FIGS. 15a and 15b. In FIG. 16, user makes his driver choice and clicks continue. In FIG. 17, user inputs his wall voltage.

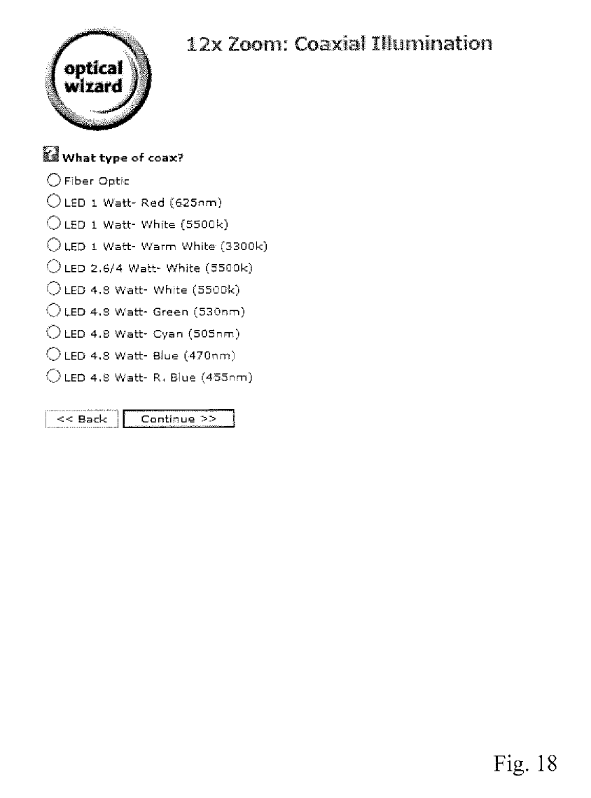

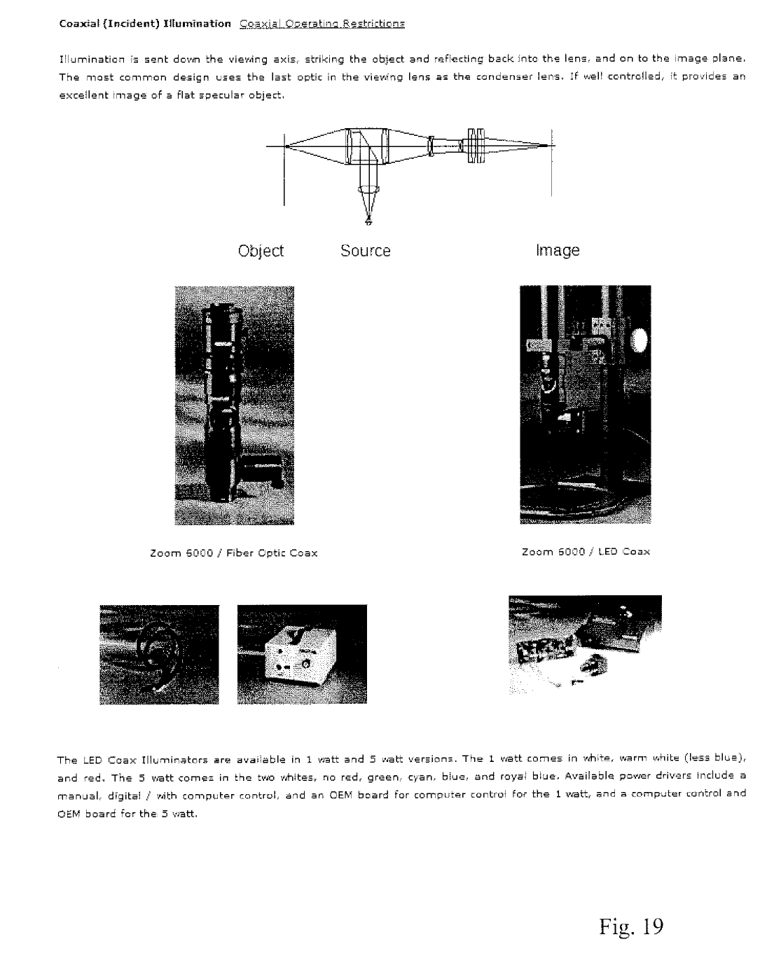

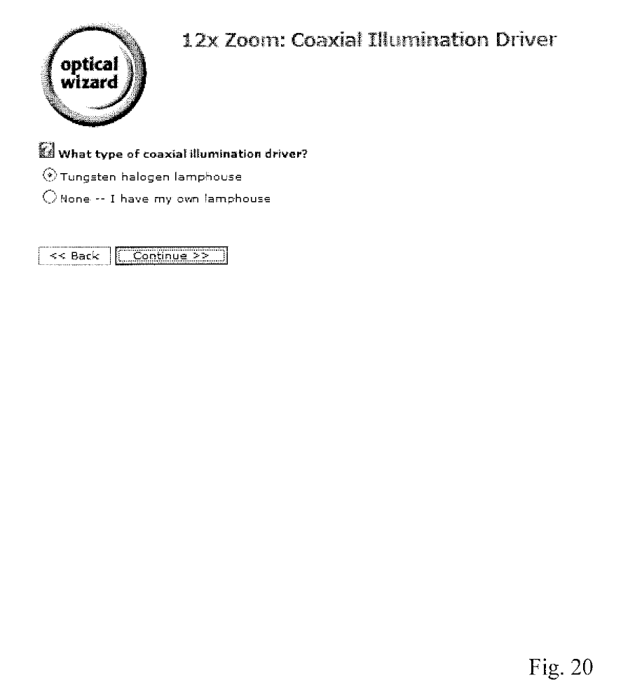

In response to the above, the central station now inquires, in screen shown in FIG. 18, “What type of coax?”0 In response, user seeks the relevant help section, in screen shown in FIG. 19. Then user decides on a coax and driver, see screen depicted in FIG. 20.

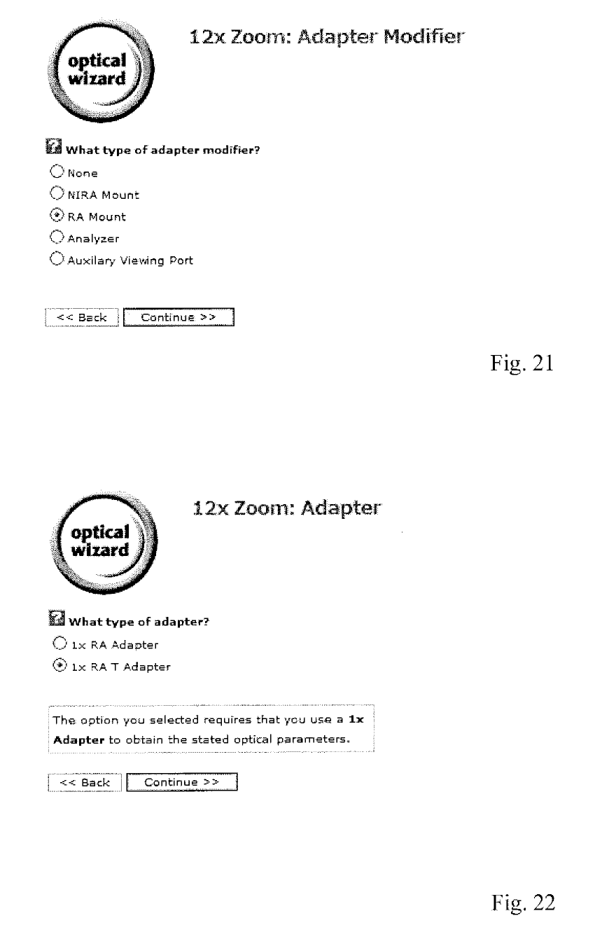

Then, user checks the relevant help section regarding the adapter modifier, and picks one on the screen of FIG. 21 that lets him bend his system. In FIG. 22, the screen user receives enables him to pick the adapter, but he only receives the possibilities that will work with the bent modifier.

In the screen shown in FIG. 22, the Wizard confirms that the correct lens attachment has been selected. User then checks the help section appropriate to mounts, and decides that he wants a mount. On the screen provided by the central station asking “What type of mount?”, user ticks “76 mm adapter plate”, and continues.

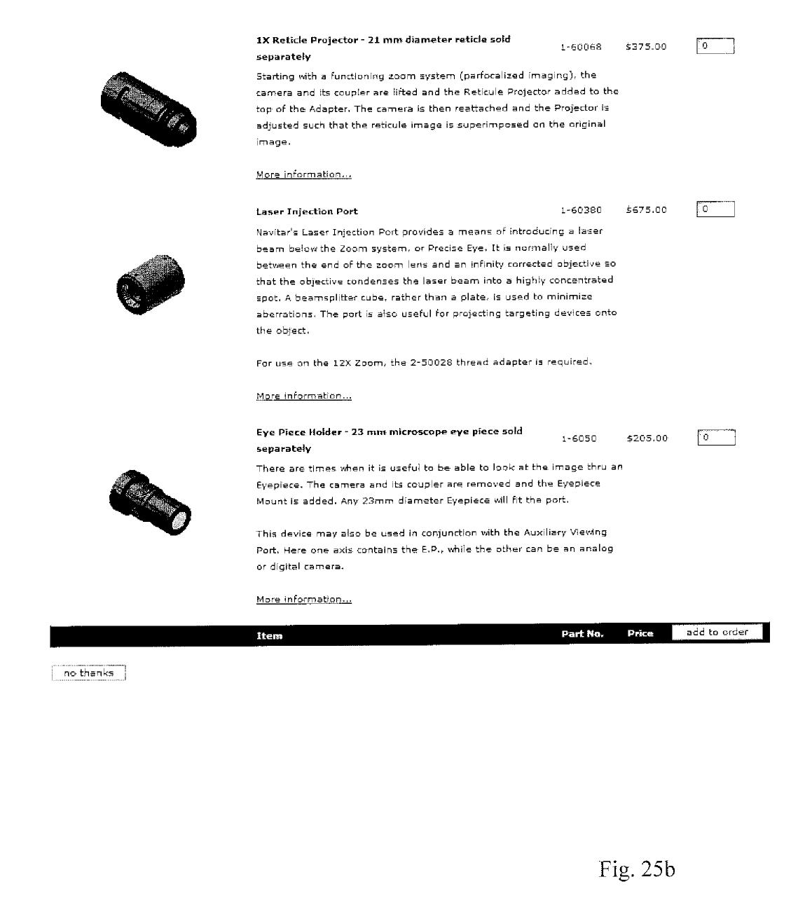

User now looks at the accessories page, screen shown in FIGS. 25a and 25b, for the 12× Zoom, and decides that he wants a digital camera adapter.

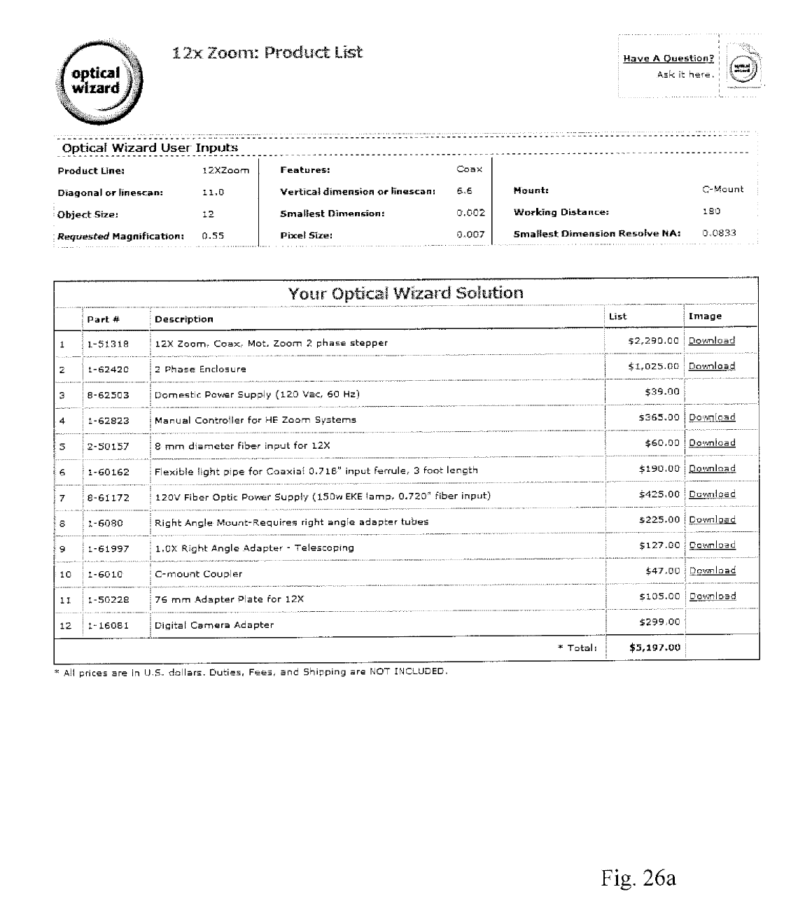

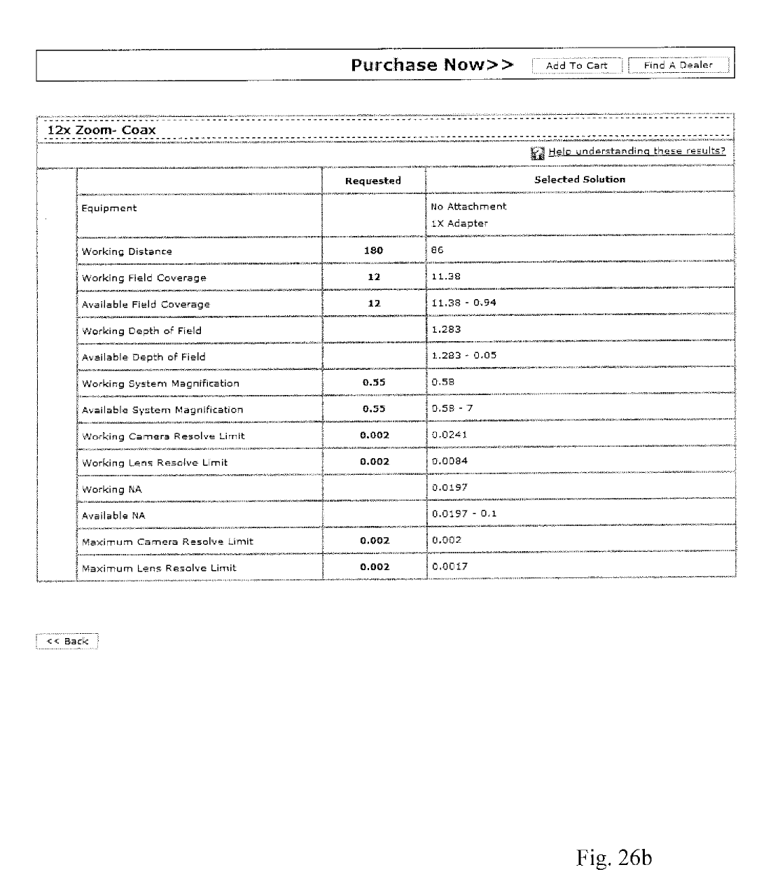

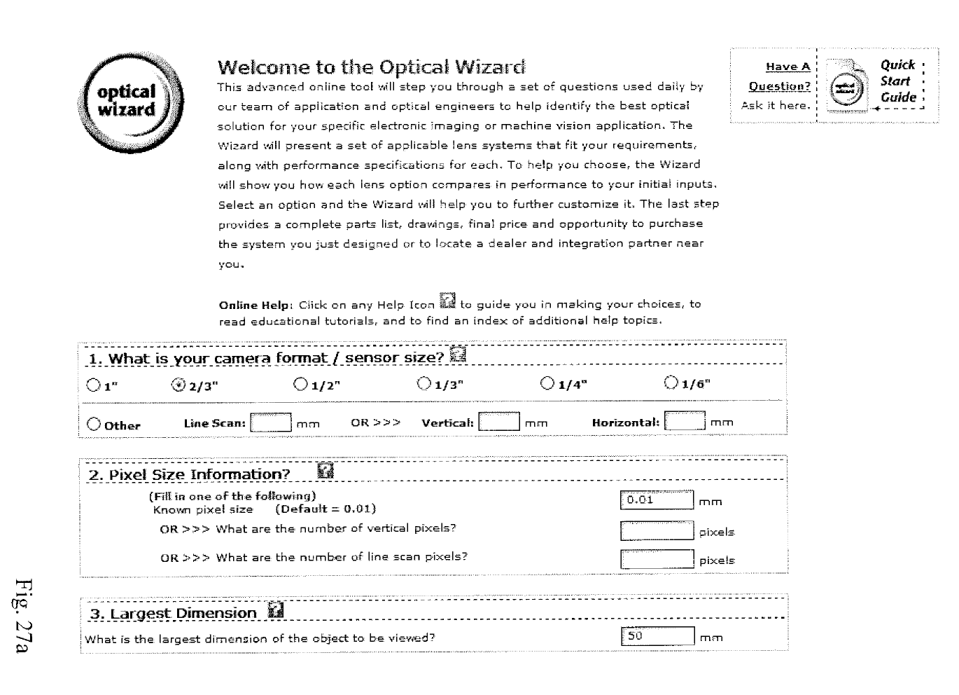

In FIGS. 26a and 26b, the final screen or page is shown. The contents of the final page are the Inputs, as revised, the Optical Wizard solution showing part numbers, parts, list price and the possibility of downloading, a final price, the option to purchase now or find a dealer, and the requested optical characteristics and the selected solution optical characteristics. Thus, the final page shows all the equipment that the user has selected, plus any additional pieces required to make the equipment work, plus the Wizard has provided all of the various optical operating parameters of the final system as the user has configured it. The final page shows a list of complete parts, drawings and a final price, together with an option to purchase immediately online or alternatively, to locate a dealer and integration partner convenient to the user.

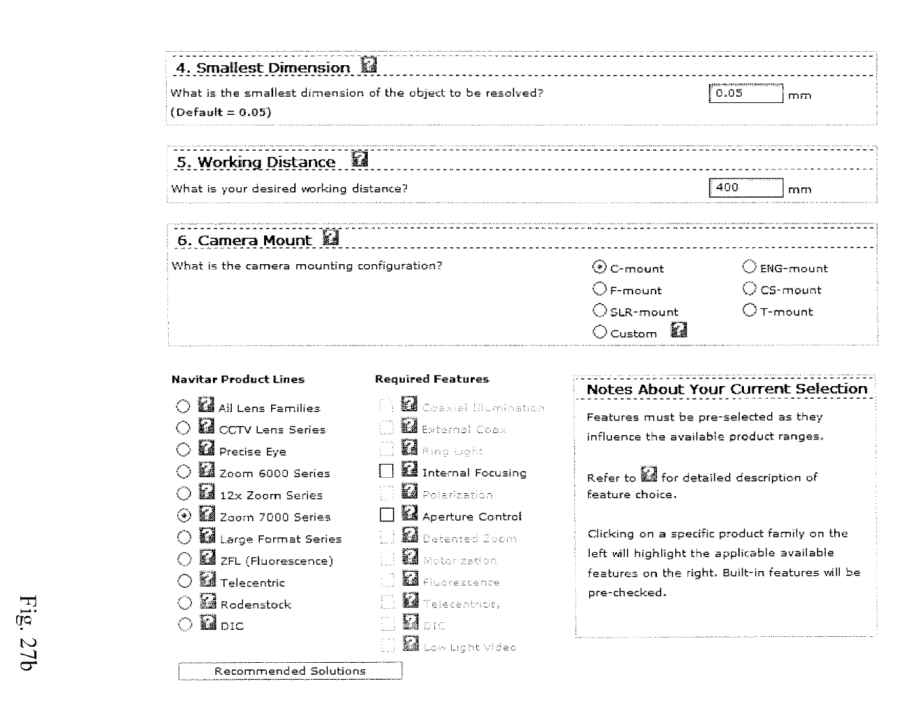

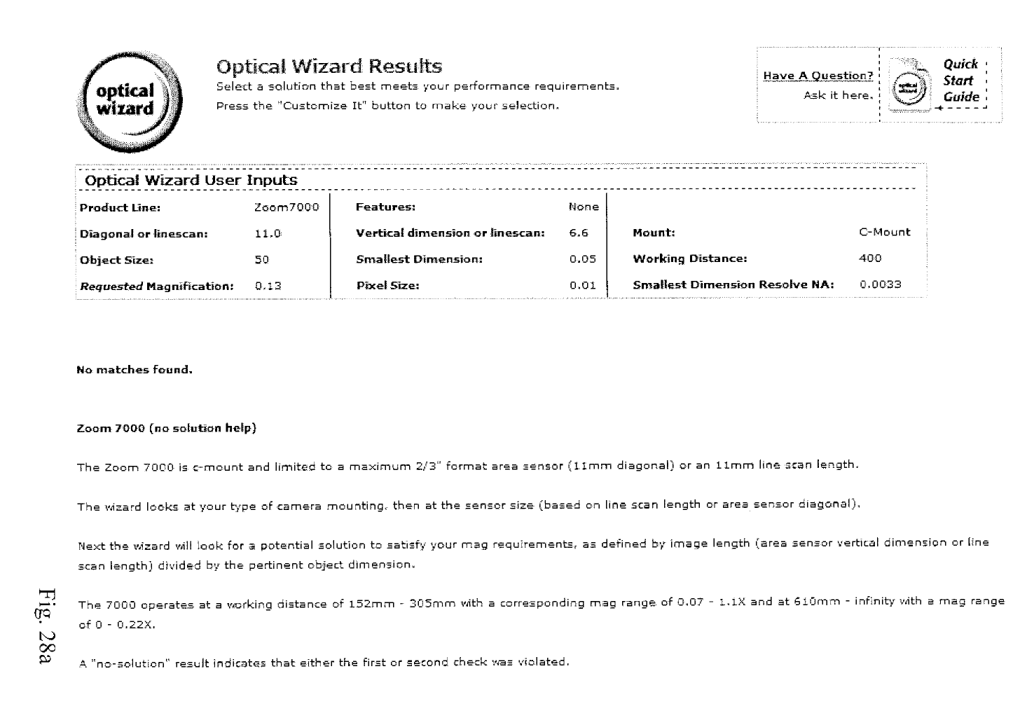

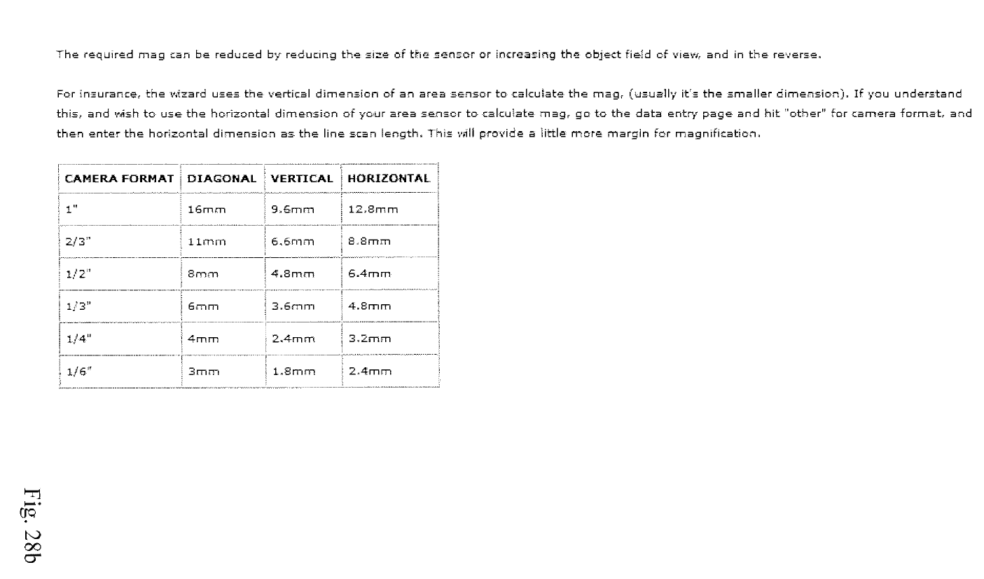

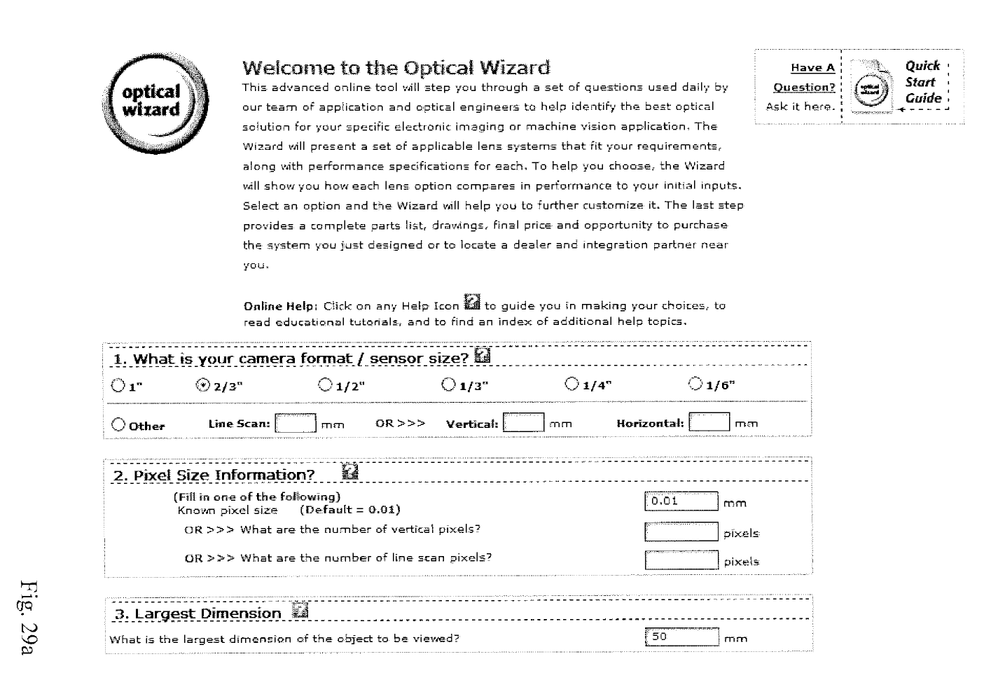

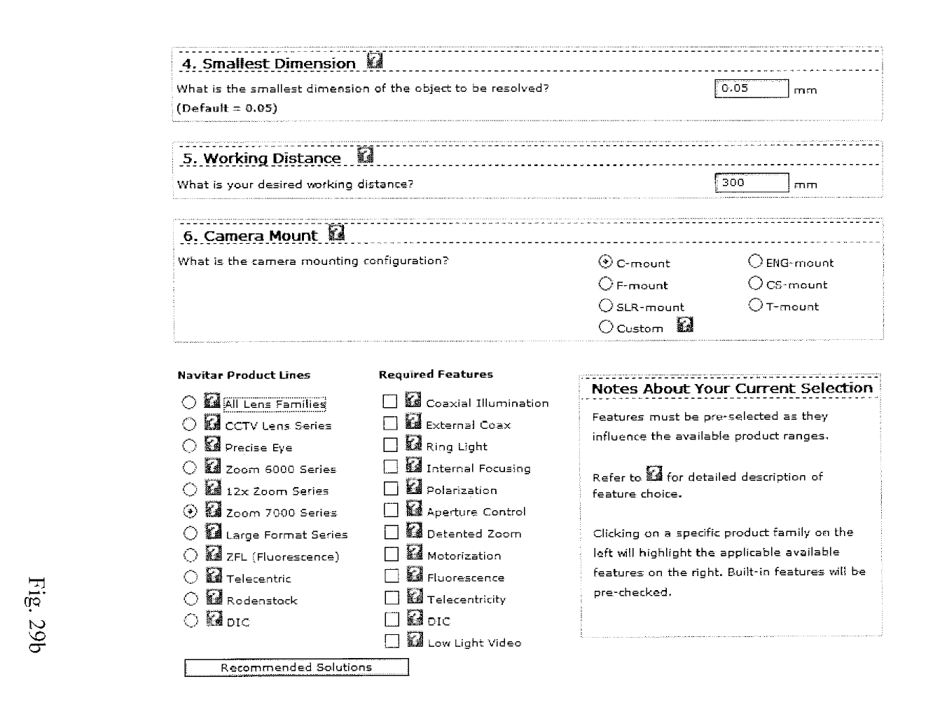

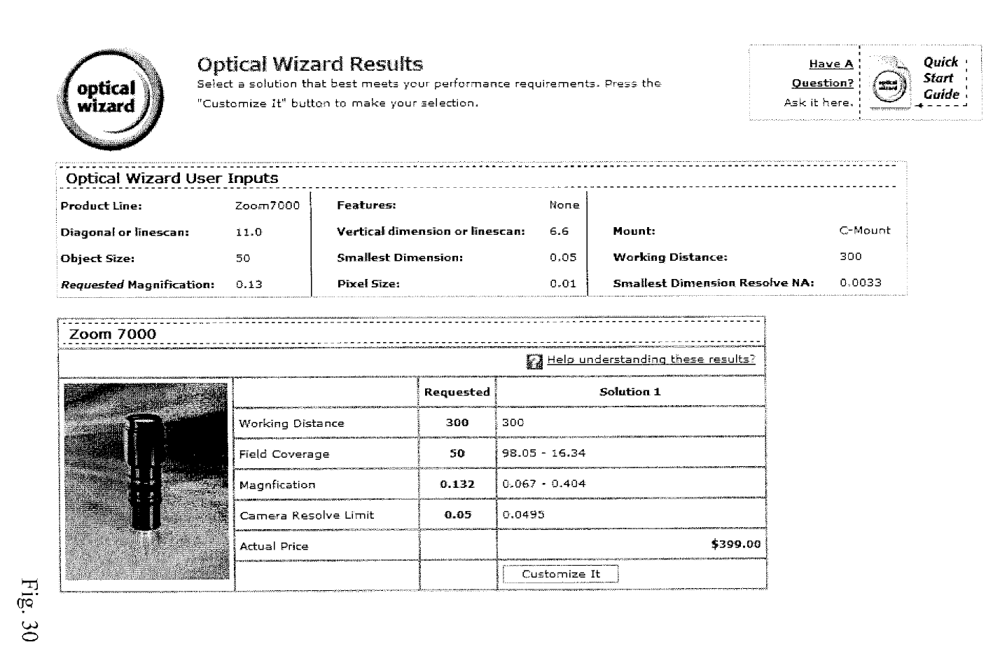

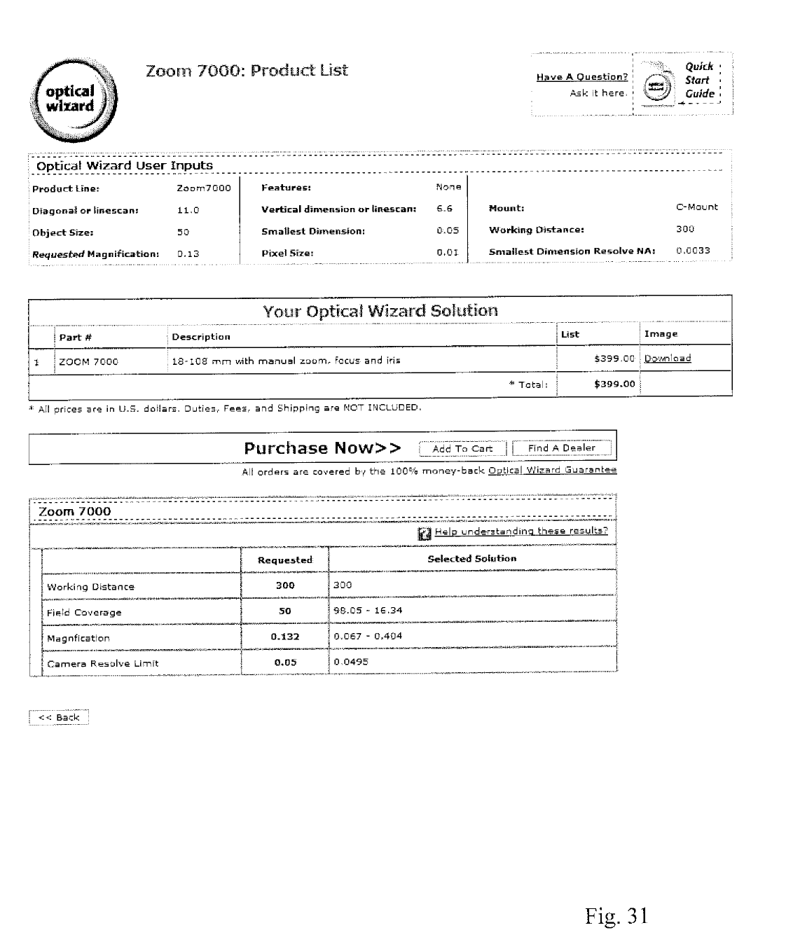

There now follows another example of the invention, but a simpler situation. In the input screen or page, shown in FIGS. 27a and 27b, the user provides his inputs that include specifying a working distance of 400 mm. In FIGS. 28a and 28b, the Wizard advises the user that his inputs won't work (no matches found) and shows him probable cause for the lens system he wishes, namely, Zoom 7000. In the screen or on the page shown in FIGS. 29a and 29b, user adjusts his input for working distance from 400 mm to 300 mm. In the screen, now presented to user from the central station, see FIG. 30, the Wizard announces a solution and presents the revised inputs and the Zoom 7000 lens that provides the user with the solution, together with the ranges of magnification and fields of view at the revised working distance, and the cost. In the next screen or page, see FIG. 31, the Optical Wizard formally presents the summary of the transaction and gives the user the opportunity to purchase online, or to find a dealer.

It is to be understood that the specific systems, methods and techniques which have been described above are merely illustrative of the invention. Numerous modifications, based on the teachings disclosed herein may be made to the system as described without departing from the true spirit and scope of the invention.

What is claimed:

1. An interactive automated method for designing an optical system for imaging an object to meet a user's specific imaging need comprising the steps of:
A. establishing a connection via Internet between a user and a central station that interactively and automatically designs by a computer application in a single session an optical system for imaging an object using products of a specific product line;
B. sending by the central station, in response to a request by a user, via the Internet connection an input screen to the user for input of the user's specific imaging need for a desired optical system, said screen including blank spaces for user inputs of; (i) basic inputs of camera format or line scan length, number of vertical pixels or linear pixels, largest dimension of object to be viewed, and desired working distance and camera mounting configuration wherein the pixel size and smallest dimension have set default values in the event the user does not input any values; and (ii) accessory inputs regarding user's desires for coaxial illumination, external illumination, ring light or uni-lite, internal focusing, polarization, aperture control, detented zoom, motorization, autofocus, flourescense, telecentricity, DIC and low light vision; and a product input for selection of a product from the specific product line; said basic inputs, accessory inputs and product input collectively constituting user's first inputs;
C. inputting by user the user's first inputs by filling in on the screen the basic inputs, user's desires regarding the accessory inputs and any selection of a product;
D. sending interactively by the user via the Internet user's first inputs to the central station;
E. receiving interactively and automatically by the central station via the Internet the user first inputs and automatically converting the received user's first inputs into a first set of user optical characteristics and saving in memory;
F. storing in memory at the central station for each product of the specific product line its optical characteristics including largest image format, camera mounting, mag-macro, WD-macro, coax, external illumination, detents, motorization, resolve limit-macro, light gathering, internal focus, polarization, aperture diameter, cam to object length, parfocal zoom, N.A. micro, depth of field macro, and auto-focus;
G. providing at the central station a data processor programmed with a set of instructions for automatically carrying out the conversion of step E to obtain the first set of user optical characteristics;
H. if a product of the specific product line has been selected by the user; (1) comparing automatically via the programmed data processor the first set of user optical characteristics and the optical characteristics of the selected product to determine disparities and modifications of user's first inputs required to obtain a closer possibility for matching in terms of the user's specific imaging need, (2) sending interactively and automatically to the user and displaying to the user, disparities in optical characteristics and the choices available for modifying user first inputs to satisfy user's specific imaging need to move closer toward a match including an explanation of what the choices mean, (3) in response to step (2) modifying the user's first input according to selected choices to create user's second inputs and sending interactively by the user and receiving interactively at the central station the user's second inputs determined by modifying the user's first inputs according to selected choices, (4) converting interactively and automatically at the central station the user's second inputs into a second set of user optical characteristics and saving in memory, (5) comparing automatically via the programmed data processor the second set of user optical characteristics and the optical characteristics of the selected product to determine (a) if the central station can design an optical system that satisfies the user's specific imaging need, said optical system comprised of camera mount, lenses, accessories and spacers that perform within a predetermined tolerance range, (β) if so, then reporting to user, and (γ) if not, determining any remaining disparities and further modifications required to obtain a closer matching in terms of the user's specific imaging need, (6) sending interactively and automatically by the central station to the user and displaying to the user, the remaining disparities in optical characteristics in terms of the user's specific imaging need and choices available for modifying user current inputs including an explanation of what the choices mean, and (7) repeating steps (2) to (6) interactively and automatically until the central station can design an optical system that satisfies the user's specific imaging need, said optical system comprised of camera mount, lenses, accessories and spacers that performs within a predetermined tolerance range, and (h) reporting to user;
I. if a product of the specific product line has not been selected; (I) comparing automatically via the programmed data processor the first set of user optical characteristics and the optical characteristics of all specific product lines to determine any possibilities for matching in terms of the user's specific imaging need, (II) based on a possibility of matching, sending interactively and automatically to the user and displaying to the user, the disparities of the optical characteristics of any possible products in terms of the user's specific imaging need and the choices available for modifying user first inputs to move closer to a match including an explanation of what the choices mean, (III) in response to step (II), modifying the user's first inputs according to selected choices to create user's second inputs and sending interactively by the user and receiving interactively by the central station the user's second inputs, (IV) converting automatically at the central station the user's second inputs into a second set of user optical characteristics and saving in memory, (V) in response thereto, comparing automatically via the programmed data processor the second set of user optical characteristics and the optical characteristics of the possible matching product to determine (x) if the central station can design an optical system that satisfies the user's specific imaging need, said optical system comprised of camera mount, lenses, accessories and spacers that performs within a predetermined tolerance range, (xx) if so, then reporting to user, and (xxx) if not, determining any remaining disparities and further modifications required to obtain a closer matching, (VI) sending interactively and automatically to the user and displaying to the user any remaining disparities in the optical characteristics in terms of the user's specific imaging need and the choices available for modifying user's current inputs including an explanation of what the choices mean, and (VII) repeating steps (II) to (VI) interactively and automatically until the central station can design automatically via the computer application an optical system comprised of camera mount, lenses, accessories and spacers that satisfies the user's specific imaging need, said optical system comprised of camera mount, lenses, accessories and spacers that performs within a predetermined tolerance range; and (VIII) automatically reporting to user.

2. An interactive automated method for designing an optical system for imaging an object according to claim 1 including the further step of accessing help screens stored in the computer that explain to the user explanations and options for revision or selection of components.

3. An interactive automated method for designing an optical system for imaging an object according to claim 1 including the further step of providing to the user a representative picture of the designed optical system with rough dimensions.

4. An interactive automated method for designing an optical system for imaging an object according to claim 1 including the further step of pricing the designed optical system and reporting to the user.

5. An interactive automated method for designing an optical system for imaging an object according to claim 1 including the further step of giving to the user the option of purchasing the designed optical system online or locating a dealer.

6. An interactive automated method for designing an optical system for imaging an object according to claim 1 including the further steps of designing the optical system first and then giving the user the opportunity of selecting accessories.
